(19) United States
(12) Patent Application Publication
(10) Pub. No.: US 2026/0032399 A1
(43) Pub. Date: Jan. 29, 2026

(54) RENDERING TECHNIQUES

(71) Applicant: Fraunhofer-Gesellschaft zur Förderung der angewandten Forschung e.V., München (DE)

(72) Inventors: Nils PETERS, Erlangen (DE); Andreas SILZLE, Erlangen (DE); Alexander ADAMI, Erlangen (DE); Sascha DISCH, Erlangen (DE)

(21) Appl. No.: 19/349,370

(22) Filed: Oct. 3, 2025

Related U.S. Application Data
(63) Continuation of application No. PCT/EP2024/059140, filed on Apr. 4, 2024.

(30) Foreign Application Priority Data
Apr. 5, 2023 (EP) 23166879.9

(51) Int. Cl. H04S 7/00

(52) U.S. Cl. CPC H04S 7/302; H04S 2400/11; H04S 2420/03

(57) ABSTRACT

There is disclosed renderer apparatus, comprising: a rendering unit configured to process an audio scene representation to be rendered and to receive at least one context-specific rule or parameter, the rendering unit being configured to generate a rendered audio signal from the audio scene representation conditioned by the at least one context-specific rule or parameter, a contextualization unit configured to receive and/or derive context-specific data, the contextualization unit being configured to provide the at least one context-specific rule or parameter to the rendering unit based on the context-specific data.

### CROSS-REFERENCE TO RELATED APPLICATIONS

This application is a continuation of copending International Application No. PCT/EP2024/059140, filed Apr. 4, 2024, which is incorporated herein by reference in its entirety, and additionally claims priority from European Application No. EP 23166879.9, filed Apr. 5, 2023 which is also incorporated herein by reference in its entirety.

The present invention refers to audio rendering, e.g. for vehicles and/or for hearing-impaired aid.

### BACKGROUND OF THE INVENTION

The inventors have noted that audio renderers provide audio rending which is in general independent of the user or on the environment in which the user consumes the audio content. E.g. in the case of virtual reality (VR), augmented reality (AR), etc., even if the user provides some sort of feedback, this feedback remains restricted to the options provided by the particular audio scene, and does not necessarily suite to the particular profile of the user. Said in other terms, the feedback provided by the user is feedback which is foreseen by the authors (e.g. head's movements for permitting to see different viewports and hear different sounds), but cannot be really tailor-made on the specific user. For example, if the user is hearing-impaired, a rendering of the audio scene would be advantageous which keeps into account the impaired state of the user, and even better a redefinition of the content to adapt to the user's sensitivity would be pursued. However, this operation should be performed during authoring, and this would increase the burden for the authors' generation of the content.

A particular example is discussed here below.

With the promise and aim of Social VR and the Metaverse to connect all people, audio technology needs to be designed to address users of all ages and within a wide range of hearing abilities. However, for most consumer electronics, the usual target user group is the normal hearing population, while people with impaired abilities receive little consideration. The populations of all industrial nations are aging rapidly. The number of people above the age of 67 in Germany will increase by 22% until 2035. Already, the median age in Germany or Japan is about 48 years. Worldwide, the group of people above 65 years old will grow significantly more than the overall population.

According to the study Hearing loss in the elderly—characteristics and location (https://www.aerzteblatt.de/archiv/48807/Hoerminderung-im-Alter-Auspraegung-und-Lokalisation), “In old age, hearing loss has a high statistical probability, although it is not a natural process. [ . . . ] The majority of hearing loss in old age results from changes in the inner ear haircells as well as degenerative processes of the central auditory pathway. Only 15% of elderly people with a clear indication for needing a hearing aid are actually using one. Reasons for this insufficient supply are too high expectations towards hearing aids, bad acceptance, and technically unsolved speech processing strategies for the compensation of the central neural components of presbyacusis which seem to play a greater role in old age.” This publication is from 2005, but this situation generally has not changed.

The global hearing aids market is projected to grow from $10.23 billion in 2022 to $17.68 billion by 2029 and the recently FDA-approved Over-The-Counter hearing aid segment will be a significant part of it.

VR/AR (with MPEG-I as one manifestation) can
a) adapt to this large and often wealthier user group by taken the hearing impairments into account and lower the boarder for using these technologies also as a hearing impaired person
b) Enable Social VR, Metaverse, and other upcoming communication concepts to a population
c) open specific fields of AR/VR applications for hearing impaired people. This can be training and learn sessions about how to use the new hearing device, or combine hearing devices with the general AR technology to enrich aural information by e.g., visual transcripts of the heard speech in AR glasses. Alternatively, dereverberation techniques could be applied to increase speech intelligibility.

Consequences of cochlear hearing loss are degradation in a) audibility (raised hearing thresholds), b) loudness perception (reduced dynamic range) and c) frequency separation (identify auditory objects in complex sound scenes) [1].

A common strategy to adapt the audio for impaired listener is a post-filter 120, which takes the (rendered) stereo output 112 (outputted by a rendering unit 110) and generates a personalized audio signal by applying frequency-dependent amplification (EQ), frequency-dependent Dynamic Range Compression/Automatic Gain Control (DRC/AGC) adjustments and (in more severe cases) frequency lowering (see FIG. 1). The parameters for the EQ and the loudness adjustment were determined beforehand and stored in a hearing loss profile, e.g., by a hearing-aid specialist, or by a hearing test app on the user's phone. Common techniques to map frequency-dependent hearing loss to amplification (primarily to improve speech intelligibility) are CAMEQ, CAMREST, DSL[i/o], FIG. 6, or NAL-NL1.

To account for severe high-frequency hearing loss, a technique called frequency lowering (FL) is used. Here, the spectrum is compressed and shifted so that frequency components in regions with severe hearing loss (usually high-frequencies) appear in the frequency regions with less hearing loss.

Commonly, when a wireless link (e.g., Bluetooth) exists between the playout device (where the rendering occurs) and the headphone or hearing aid, the audio adaptation might be processed on the headphone/hearing aid. This additional processing may add undesired latency and decreases the uptime of the hearable due to increased complexity and consequently battery consumption.

Devices in the newly established Over-the-counter (OTC) hearing aids product category primarily focus more on improving speech clarity in noisy environments rather than on the selective amplification to counter hearing loss.

In the context of Object-Based Audio, accessibility has been investigated e.g., in [2]-[4].

A problem with the prior-art solutions is that the audio adaptation can only affect the rendered signals (after the rendering output). This is non-ideal, due to the increased latency, complexity, and also the limited possibilities of creating a more accessible audio stream.

There have been studied the possibility of implementing HRTFs (Head-Related Transfer Functions). However, the HRTFs don't operate on the decoding or rendering, but on the already decoded (or already rendered) audio signal. Hence, the problems of conventional technology are maintained.

By virtue of the above, it is expected to find out a rendering technique which permits personalization or environment-specific adaptation.

### SUMMARY

According to an embodiment, a renderer apparatus may have:
a rendering unit configured to process an audio scene representation to be rendered and to receive at least one context-specific rule or parameter, the rendering unit being configured to generate a rendered audio signal from the audio scene representation conditioned by the at least one context-specific rule or parameter, the context-specific rule or parameter compensating a hearing-impairment; and
a contextualization unit configured to receive and/or derive context-specific data, the contextualization unit being configured to provide the at least one context-specific rule or parameter to the rendering unit based on the context-specific data.

According to another embodiment, a rendering method may have:
processing an audio scene representation generating a rendered audio signal from the audio scene representation conditioned by at least one context-specific rule or parameter, the context-specific rule or parameter compensating a hearing-impairment,
the method including generating the at least one context-specific rule or parameter based on the context-specific data.

Another embodiment may have a non-transitory digital storage medium having a computer program stored thereon to perform the inventive audio rendering method, when said computer program is run by a computer.

In accordance to an aspect there is provided a renderer apparatus, comprising:
a rendering unit configured to process an audio scene representation to be rendered and to receive at least one context-specific rule or parameter, the rendering unit being configured to generate a rendered audio signal from the audio scene representation conditioned by the at least one context-specific rule or parameter,
a contextualization unit configured to receive and/or derive context-specific data, the contextualization unit being configured to provide the at least one context-specific rule or parameter to the rendering unit based on the context-specific data.

In accordance to an aspect, the rendering unit is configured to process the audio scene representation as including audio elements, the rendering unit being configured to generate the rendered audio signal from the audio elements and the at least one context-specific rule or parameter.

In accordance to an aspect, the rendering unit is configured to process the audio scene representation including audio elements and metadata, the rendering unit being configured to generate the rendered audio signal from the audio elements, the metadata and the at least one context-specific rule or parameter.

In accordance to an aspect, the metadata include positional metadata which provide information on at least one of a position, orientation, directivity, source, and width of at least one object to be rendered, the at least one object to be rendered being part of the audio scene representation, wherein the rendering unit is configured to generate the rendered audio signal from the audio elements, the metadata, and the at least one context-specific rule or parameter.

In accordance to an aspect, the rendering unit is configured to modify the metadata based on the at least one context-specific rule or parameter to obtain modified metadata, wherein the rendering unit is configured to apply a spatial audio processing and synthesis to the audio elements based on the modified metadata.

In accordance to an aspect, the rendering unit is configured to apply a spatial audio processing and synthesis to the audio elements based on the metadata and the at least one context-specific rule or parameter.

In accordance to an aspect, the rendering unit is configured to combine the audio elements based on the metadata and the at least one context-specific rule or parameter In accordance to an aspect, the contextualization unit is configured to define the at least one context-specific rule or parameter to include a context-specific positional rule or parameter which associates context-specific gain weights with distances, positions, gestures and/or orientations, to correspondently apply a context-specific gain weight to an object to be rendered based on the context-specific positional rule or parameter.

In accordance to an aspect, the context-specific positional rule or parameter defines the gain weights to be frequency-dependent, so that the rendering unit applies, according to the positional rule or parameter, a first context-specific gain weight to a first frequency band, and a second context-specific gain weight to a second frequency band.

In accordance to an aspect, the contextualization unit is configured to define the at least one context-specific rule or parameter to include a context-specific positional rule or parameter based on a distance threshold or position threshold or orientation threshold, wherein the rendering unit is configured to compare a distance or position or orientation of an object to be rendered with the distance threshold or position threshold or orientation threshold, respectively, so as to refrain from rendering the object in case the distance or position or orientation is over the distance threshold or position threshold or orientation threshold, and render the object in case the distance or position or orientation is below the distance threshold or position threshold or orientation threshold.

In accordance to an aspect, the contextualization unit is configured to define the at least one context-specific rule or parameter to be based on a context-specific gain threshold, wherein the rendering unit is configured to compare the gain of an object to be rendered with the context-specific gain threshold, so as to refrain from rendering the object in case the gain is below the context-specific gain threshold, and render the object in case the gain is over the context-specific gain threshold.

In accordance to an aspect, the contextualization unit is configured to define the at least one context-specific rule or parameter to include a positional rule or parameter stating a distance-dependent attenuation or position-dependent attenuation or orientation-dependent attenuation, of the gain of an object to be rendered, wherein the positional rule or parameter includes a context-specific attenuation parameter to be applied to the context-specific distance-dependent attenuation or position-dependent attenuation or orientation-dependent attenuation.

In accordance to an aspect, the contextualization unit is configured to define the position-dependent attenuation as a distance-dependent attenuation inversely proportional to a distance of an object to be rendered elevated by an exponent defined by the context-specific attenuation parameter.

In accordance to an aspect, the contextualization unit is configured to define the position-dependent attenuation as a distance-dependent attenuation, inversely proportional to a distance of an object to be rendered, increased or reduced according to the context-specific attenuation parameter.

In accordance to an aspect, the contextualization unit is configured to define the at least one context-specific rule or parameter to provide context-specific information on at least one channel-specific gain weight to be applied to a corresponding audio element of the rendered audio signal, so that the rendering unit applies the channel-specific gain weight to the corresponding audio element of the rendered audio signal.

In accordance to an aspect, the channel-specific weight includes a plurality of channel-specific gains, each channel-specific gain being specific to each frequency band, so that the rendering unit applies, according to the at least one context-specific rule or parameter, a first channel-specific gain weight to a first frequency band, and a second channel-specific gain weight to a second frequency band.

In accordance to an aspect, the contextualization unit is configured to define the at least one context-specific rule or parameter to include a context-specific reverberation level reducing rule or parameter, so that the renderer unit performs a context-specific reduction of the reverberation level based on the context-specific reverberation level reducing rule or parameter.

In accordance to an aspect, the contextualization unit is configured to define the at least one context-specific rule or parameter to include a context-specific early reflection level reducing rule or parameter, so that the rendering unit performs a context-specific reduction of the early reflection level based on the context-specific early reflection level reducing rule or parameter.

In accordance to an aspect, the contextualization unit is configured to define the at least one context-specific rule or parameter to include a dynamic range control rule or parameter, so that the rendering unit performs dynamic range control based on the dynamic range control rule or parameter.

In accordance to an aspect, the contextualization unit is configured to derive the context-specific rule or parameter from background noise, so as to apply a higher gain to the rendered audio signal in the case of higher background noise, and a lower gain to the rendered audio signal in case of lower background noise.

In accordance to an aspect, the contextualization unit is configured to define a context-specific floor damping parameter to be used by the rendering unit to perform floor damping according to the context-specific floor damping parameter.

In accordance to an aspect, the contextualization unit is configured to define a context-specific culling gain parameter to be used by the rendering unit to perform linear fade-out of objects which are closer to a first source distance culling value for first-order reflections or to perform linear fade-out of objects which are closer to a second source distance culling value for second-order reflections.

In accordance to an aspect, the contextualization unit is configured to define a context-specific culling gain parameter to be used by the rendering unit to modify cylinder reflections.

The renderer apparatus according to an aspect, configured to process the audio scene representation to obtain a version of the audio scene representation including audio elements, the renderer apparatus being further configured to generate the rendered audio signal from the audio elements and metadata.

The renderer apparatus according to an aspect, configured to process the audio scene representation to obtain a version of the audio scene representation including audio elements and metadata, the renderer apparatus being further configured to generate the rendered audio signal from the audio elements and the metadata.

The renderer apparatus according to an aspect, configured to process the audio scene representation to obtain a version of the audio scene representation including audio elements in a core decoder block, and to process the version of the audio scene representation to generate the rendered audio signal from the audio elements in a rendering block.

In accordance to an aspect, the at least one context-specific rule or parameter includes a context-specific rule or parameter for frequency band changing, which associates input frequency bands with output frequency bands, so that the rendering unit changes at least one frequency band of the audio scene representation onto a different frequency band of the audio elements according to the context-specific rule or parameter for frequency band changing.

In accordance to an aspect, the context-specific rule or parameter for frequency band changing reduces the frequency of at least one frequency band.

In accordance to an aspect, the at least one context-specific rule or parameter includes a context-specific rule or parameter for frequency-dependent gain amplification which associates input frequency bands with context-specific frequency band weights, so that the rendering unit correspondently applies a context-specific gain weight to the spectral value of at least one bin of at least one frequency band according to the context-specific rule or parameter.

In accordance to an aspect, the contextualization unit is configured to define the at least one rule or parameter as a geometric extent.

In accordance to an aspect, the renderer apparatus may be configured to use the at least one least one context-specific rule or parameter including a suggested amplification curve for each channel, the suggested amplification curve following a contextualization profile based on the context-specific data.

In accordance to an aspect, the renderer apparatus may be configured to use the at least one context-specific rule or parameter as being parametrized on a parameter or on a measured value, so as to modulate the at least one context-specific rule or parameter according to the parameter or the measured value.

In accordance to an aspect, the rendering unit is configured to process the audio scene representation to derive a version of the audio scene representation as including, in metadata, a plurality of metadata sets, wherein the rendering unit is configured to discharge one of the metadata sets based on the at least one context-specific rule or parameter.

In accordance to an aspect, the contextualization unit is configured to define the at least one context-specific rule or parameter based on a contextualization profile including a plurality of the context-specific data, the contextualization unit being configured to extract, from the contextualization profile, the context-specific data relevant to the audio signal to be rendered and/or a rendering configuration, and to derive the at least one context-specific rule or parameter from the relevant context-specific data.

In accordance to an aspect, the contextualization unit is configured to define the at least one context-specific rule or parameter based on parameters of the rendering unit, in such a way that the at least one context-specific rule or parameter adapts the parameters of the rendering unit to the contextualization profile.

The rendering unit according to an aspect, wherein the contextualization unit is configured to derive a degradation model from the contextualization profile and/or the context-specific data, the degradation model being indicative a specific degradation of the capability of acquiring the rendered audio signal by a specific human user or another audio-receiving entity, wherein the contextualization unit is further configured, based on the degradation model, to define the at least one context-specific rule or parameter to compensate for the specific degradation.

According to an aspect, the renderer apparatus, may be configured to perform a simplified rendering in case of determining that the user has an impaired hearing and/or has a reduced cognitive and/or physical sensitivity.

In accordance to an aspect, the contextualization unit is configured to define the at least one context-specific rule or parameter based on contextualization settings received in the audio scene representation.

In accordance to an aspect, the contextualization unit is configured to select the at least one context-specific rule or parameter from a plurality of contextualization settings received in the audio scene representation, and to select, among the plurality of received contextualization settings, the most suitable context-specific rule or parameter based on feedback, such as user-specific physical and/or cognitive hearing degradation information, from the user, or from pre-settings, or from a manual selection.

In accordance to an aspect, the contextualization unit is configured to access to user-specific physical and/or cognitive hearing degradation information providing information on a user-specific physical and/or cognitive hearing degradation, and to define the at least one context-specific rule or parameter as a user-specific rule or parameter based on the user-specific physical and/or cognitive hearing degradation information.

In accordance to an aspect, the user-specific physical and/or cognitive hearing degradation information is, or includes, information on cochlear degradation of a user.

In accordance to an aspect, the contextualization unit is configured to generate the at least one context-specific rule which is a user-specific rule or parameter to compensate the user-specific physical and/or cognitive hearing degradation.

According to an aspect, the renderer apparatus may be configured to perform a configuration session to acquire the user-specific physical and/or cognitive hearing degradation information through a plurality of acquisitions to therefore derive a user-specific physical and/or cognitive hearing degradation model, and to derive the at least one context-specific rule or parameter by applying parameters which are directed to compensate the user-specific physical and/or cognitive hearing degradation model.

According to an aspect, the renderer apparatus may be configured to perform an upload session to upload user-specific physical and/or cognitive hearing degradation information to derive a user-specific physical and/or cognitive hearing degradation model, and to derive the at least one context-specific rule or parameter by applying parameters which compensate the user-specific physical and/or cognitive hearing degradation model.

In accordance to an aspect, the at least one context-specific rule or parameter associates different potential characteristics of the audio scene representation to different parameters to be applied to the audio scene representation.

In accordance to an aspect, the contextualization unit includes a simplification rule or parameter, commanding a reduction of the number of audio elements to be rendered, so that the rendering unit reduces the number of objects to be rendered.

In accordance to an aspect, the rendering unit is configured to perform a selection between:
a first, default mode, in which the rendering unit operates using at least one first selectable rule or parameter, wherein the first selectable rule or parameter is either a default rule or parameter or a first context-specific rule or parameter of the at least one context-specific rule or parameter; and
a second, contextualized mode, in which the rendering unit operates using at least one second selectable rule or parameter instead of the first selectable rule or parameter, wherein the second selectable rule or parameter is a context-specific rule or parameter of the at least one context-specific rule or parameter different from the first selectable rule or parameter.

In accordance to an aspect, the selection is controlled through a manual selection.

In accordance to an aspect, the selection is controlled through a presence or absence of the second selectable rule or parameter.

In accordance to an aspect, the selection is controlled through measurements of biological and/or physiological parameters, so as to select the first mode in case the measurements of biological and/or physiological parameters match a predetermined standard model indicative of standard user's physical and/or cognitive hearing, and to select the second, contextualized mode in case the measurements of biological and/or physiological parameters do not match the predetermined standard model, thereby indicating degraded user's physical and/or cognitive hearing.

In accordance to an aspect, the selection is controlled through measurements of biological and/or physiological parameters including EEG measurements.

In accordance to an aspect, the selection is controlled through measurements of biological and/or physiological parameters including heart rate measurements.

In accordance to an aspect, the selection is controlled through measurements of biological and/or physiological parameters including galvanic skin response.

In accordance to an aspect, the selection is controlled through a feedback signal.

The renderer apparatus, wherein the first selectable rule or parameter includes a standard, default rule or parameter independent on the context-specific data, and the second selectable rule or parameter includes the at least one contextualization selectable rule or parameter.

In accordance to an aspect, the first selectable rule or parameter includes a first context-specific rule or parameter of the at least one context-specific rule or parameter, and the second selectable rule or parameter includes a second context-specific rule or parameter of the at least one context-specific rule or parameter.

In accordance to an aspect, the selection is controlled through measurements of biological and/or physiological parameters including measurements pupillometry measures measuring the change of the pupil size.

In accordance to an aspect, the context-specific data are, or include, user-specific personalization data of a particular non-human user unit or non-human user layer.

In accordance to an aspect, the context-specific data are user-specific and provide context-specific data obtained from a feedback signal.

According to an aspect, the renderer apparatus may be configured to send the rendered audio signal to an audio consumption device.

According to an aspect, the renderer apparatus may be configured to be wirelessly connected to the audio consumption device.

According to an aspect, the renderer apparatus may be configured to receive a feedback signal from the audio consumption device indicating user's movements, positions and/or orientations, so that the rendering unit provides the rendered audio signal based on the feedback signal.

In accordance to an aspect, the rendered audio signal is part of an audio scene in a virtual reality or augmented reality environment, the rendered audio signal being defined based on the position and/or orientation of the user.

In accordance to an aspect, the rendered audio signal is part of an audio scene in a metaverse environment, the rendered audio signal being defined based on the position and/or orientation of the user in the metaverse.

In accordance to an aspect, the rendered audio signal is part of an audio scene in a video game environment, the rendered audio signal being defined based on a position and/or orientation in the video game.

In accordance to an aspect, the contextualization unit is configured to define and/or change the context-specific data based on a manual input.

According to an aspect, the renderer apparatus may be configured to receive:
a feedback signal indicating user's positional information, so that the rendering unit provides the rendered audio signal based on the feedback signal; and
wherein the rendering unit is configured to choose the rendered audio signal from the audio scene representation based on detected movements, position and/or orientation from the user's positional information,
wherein the contextualization unit is configured to define, independently of the feedback signal, the at least one context-specific rule or parameter based on the context-specific data.

According to an aspect, the renderer apparatus may be configured to receive the at least one context-specific rule or parameter with lower refreshing period than the feedback signal.

According to an aspect, the renderer apparatus may be further configured to provide visual metadata specific of the audio scene representation to a video consumption device.

In accordance to an aspect, the contextualization unit is configured to provide at least one visualization command, commanding the rendering unit to provide the visual metadata to the video consumption device.

According to an aspect, the renderer apparatus may be configured to be installed in a vehicle, the renderer apparatus being configured to receive first, contextualization feedback signal providing positional measurements on the vehicle, and a second feedback signal providing user's providing positional measurements on a user,
wherein the contextualization unit is inputted with the first, contextualization feedback signal as context-specific data and is configured to derive the context-specific rule or parameter based on the first, contextualization feedback signal, so as to:
render the audio scene representation using the on the context-specific rule or parameter; and/or render the audio scene representation based on the second feedback signal.

According to an aspect, the renderer apparatus may be configured to select between: rendering the audio scene representation using the context-specific rule or parameter; and rendering the audio scene representation based on the second feedback signal.

According to an aspect, the renderer apparatus may be configured, when rendering the audio scene representation using the on the context-specific rule or parameter, to render the audio scene in a virtual environment in solidarity with the vehicle, and configured, when rendering the audio scene representation based on the second feedback signal, to render the audio scene in solidarity with the user's position.

According to an aspect, the renderer apparatus may be configured to be inputted with the second feedback signal including positional feedback's gyroscopic and/or accelerometric measurement(s), further configured to be inputted with the contextualization feedback as including contextualization feedback's gyroscopic and/or accelerometric measurement(s), the renderer apparatus being configured to subtract the contextualization feedback's gyroscopic and/or accelerometric measurement(s) from the positional feedback's gyroscopic and/or accelerometric measurement(s), so as to use the result of the subtraction for rendering the audio scene representation.

In accordance to an aspect, the audio scene representation includes a first audio scene representation to be mixed with a second audio scene representation, wherein the first audio signal representation is to be rendered according to positional data of the vehicle and the second audio signal representation is to be rendered independently of the positional data of the vehicle, wherein the renderer apparatus is configured to mix the first audio scene representation with the second audio scene representation to obtain the rendered audio signal as a mixed version of the first audio scene representation with the second audio scene representation using mixing weights which are defined, according to the at least one context-specific rule or parameter, based on at least the positional data of the vehicle.

In accordance to an aspect, the first audio signal representation is to be rendered according to positional data is to be rendered according to a relative position of the vehicle and an external position, in such a way that the relative position conditions the mixing weights.

In accordance to an aspect, the first audio signal representation is to be rendered according to the distance of the vehicle from the external position, so as to increase the mixing weights for the second audio signal representation in case the distance is reduced, and to reduce the mixing weights for the second audio signal representation in case the distance is increased.

In accordance to an aspect, the second audio signal representation is to be rendered according to positional data of the user, in such a way that the mixing weights follow the user's positional data.

In accordance to an aspect, the renderer apparatus may be configured to receive a contextualization input as the context-specific data and a user's input to be inputted to the rendering unit, wherein the time occurrence of reception of the contextualization input is lower than the time occurrence of the user's input.

In accordance to an aspect, the renderer apparatus may be configured to receive a contextualization input as the context-specific data and a user's input to be inputted to the rendering unit, wherein the refresh frequency of the context-specific rule is lower than the input frequency of the user's input.

In accordance to an aspect, the audio elements include audio objects.

In accordance to an aspect, the audio elements include audio channels

In accordance to an aspect, the audio elements include ambisonic signals or ambisonic coefficients.

In accordance to an aspect, the rendering unit is configured to provide the rendered audio signal to an auralization unit.

In accordance to an aspect, the rendering unit provides the rendered audio signal to loudspeakers.

In accordance to an aspect, the renderer apparatus may be configured to receive the audio scene representation in a compressed version, and to perform a first decompressing operation by converting the audio scene representation into a version including the audio elements.

In accordance to an aspect, the context-specific data are, or include, user-specific personalization data of a particular human user.

In accordance to an aspect, the system may be configured to provide a mute function according to the at least one context-specific rule or parameter, the mute function being associated with a displayed output and/or a positional data of the user, in such a way that the mute function forces the audio objects of the audio signal representation to be muted in case the audio object are not displayed and/or are not within a display scope or viewport.

In accordance to an aspect there is provided a system for providing a video and audio scene, the system comprising a video renderer for decoding and rendering a video scene, and the renderer apparatus of any of the preceding aspects.

In accordance to an aspect there is provided a system for providing audio content, the system including the renderer apparatus according to an aspect, and a background noise sensor, wherein the contextualization unit is configured to derive the context-specific rule or parameter from background noise, so as to apply a higher gain to the rendered audio signal in the case of higher background noise, and a lower gain to the rendered audio signal in case of lower background noise.

In accordance to an aspect, the system may be installed in a vehicle.

In accordance to an aspect there is provided an audio rendering method, comprising:
processing an audio scene representation generating a rendered audio signal from the audio scene representation conditioned by at least one context-specific rule or parameter,
the method including generating the at least one context-specific rule or parameter based on the context-specific data.

A non-transitory storage unit storing instructions which, when executed by a processor, cause the processor to perform the method of a previous aspect.

### BRIEF DESCRIPTION OF THE DRAWINGS

Embodiments of the present invention will be detailed subsequently referring to the appended drawings, in which:

FIG. 1 shows an example according to conventional technology.

FIG. 2 shows a technique for changing frequency bands.

FIG. 3 shows an example of frequency dependent amplification.

FIGS. 4a, 4b, and 4c show examples according to the invention.

FIGS. 5a and 5b show techniques according to the invention.

FIGS. 6, 7a, 7b, 7c, and 8 show techniques according to the invention.

FIGS. 9a and 9b show examples according to the invention.

FIG. 10 shows a technique according to the invention.

FIGS. 11a, 11b, 12a, and 12b show techniques according to the invention.

### DETAILED DESCRIPTION OF THE INVENTION

### Examples

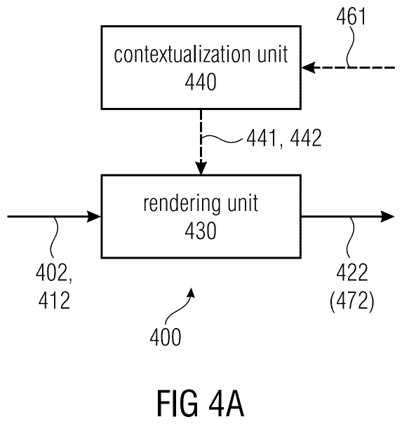

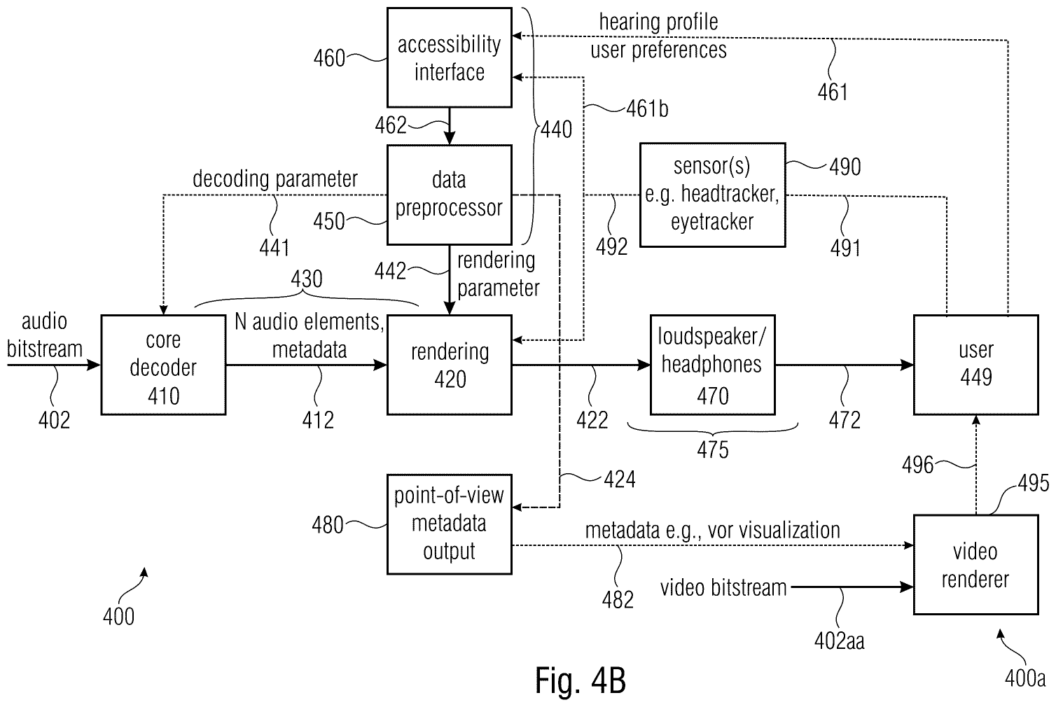

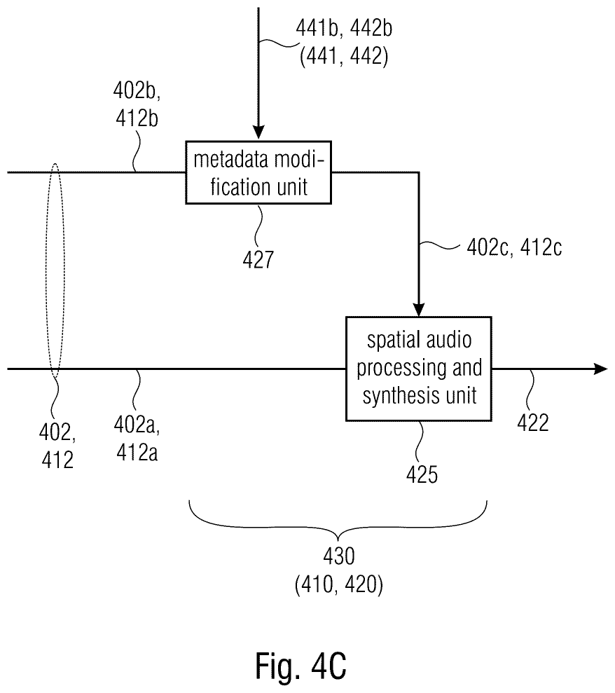

FIG. 4a shows a first, general example, of a renderer apparatus 400. The renderer apparatus 400 may comprise a rendering unit 430. The renderer apparatus may comprise a contextualization unit 440. The rendering unit may receive an audio scene representation 402 or 412 to be rendered. The rendering unit 430 may process the audio scene representation 402, 412 to generate a rendered audio signal 422 from the audio scene representation 402, 412. The contextualization unit 440 (which could be, for example, or comprise, a personalization unit) may receive and/or derive context-specific data 461 (e.g. context-specific feedback). The contextualization unit 440 may generate and/or otherwise derive at least one context-specific rule and/or parameter 441, 442 to the rendering unit 430 based on the context-specific data 461. The rendered audio signal 422 may be, for example, uncompressed audio signal. The rendered audio signal 422 may include, for each loudspeaker, a particular audio channel for each particular loudspeaker (other options are possible). The rendered audio signal may be transmitted, for example, to each loudspeaker, e.g. through a wireless (e.g. Bluetooth) connection and/or a wired connection. The audio scene representation 402, 412 may be a compressed version of the rendered audio signal 422, or anyway a version of the rendered audio signal 422 to be rendered. The rendered audio signal 422 may be, for example, a bitstream, or another representation, e.g., in terms of audio elements (e.g. audio objects, subsequently also called “objects”, downmixed audio channels, ambisonic elements, etc.).

FIG. 4b shows a more detailed view of the renderer apparatus 400 of FIG. 4a (in some cases, however, the apparatuses of FIGS. 4a and 4b may be considered two different embodiments). The renderer apparatus 400 may be part of a system 400a for providing a media scene, e.g. a video and audio scene 472, 496 (e.g. a virtual reality scene or augmented reality scene). The system 400a ay comprise a video decoder and renderer 495 for decoding and rendering a video scene (e.g. provided in compressed version 402aa), together with the renderer apparatus 400.

The renderer apparatus 400 may be independent of the system 400a and the video decoder and renderer 495. The renderer apparatus 400 may be inputted with the bitstream 402. The renderer apparatus 400 may output a rendered audio signal 422 (the bitstream 402 may be part of a media bitstream which also includes the video bitstream 402aa, if present). The renderer apparatus 400 may comprise the rendering unit 430. The rendering unit 430 may include a core decoder 410, which may be inputted with the bitstream 402. The core decoder 410 may output audio elements and, optionally, metadata (e.g. indicating at least one of position, orientation, directivity, source, and width of at least one object to be rendered). The audio elements may be, for example, channels (e.g. downmixed channels, or more in general a downmixed representation of the audio scene to be represented). In addition or in alternative the audio elements may be objects (e.g., taking into account the position of the audio sources, the directivity, etc.). In addition or in alternative the audio elements may be, or include, ambisonic elements (e.g. a compressed ambisonic representation of the audio scene to be rendered). Notably, the audio elements may include, for example, parameters (e.g. in form of metadata) which, once applied to the audio elements (e.g. objects, ambisonic elements, and/or channels) provide the rendered signal 422 of the encoded audio scene representation 402, 412. The audio elements 412 may be less compressed than the bitstream 402 in some examples. However, the audio elements 412 may not be in the necessary form for being rendered to loudspeakers.

The renderer apparatus 400 may include a renderer 420 (e.g. part of the rendering unit 430). The renderer 420 may be inputted with the audio elements 412 (channels, objects, ambisonics) and may generate a rendered audio signal 422. The rendered audio signal 422 may be provided, for example, to loudspeaker (and/or headphones 470), e.g. in wired and/or wireless form.

The rendered audio signal 422 may be, for example, in time domain. The bitstream 422 may be in a compressed format, such as frequency domain (e.g. modified discrete cosine transform MDCT, modified discrete sine transform MDST, etc.), ambisonic domain, etc. The audio elements of the audio scene representation 402, 412 may be either in time domain or in frequency or ambisonic domain, according to the particular example, and they may be converted (e.g. into the time domain) by the renderer 420 (or, in examples, more generally by the rendering unit 430). The core decoder 410 and/or renderer 420 (and more in general the rendering unit 430) may therefore in some examples perform a conversion from a compressed audio format (e.g. frequency domain) onto a time domain audio format.

The core decoder 410 and/or renderer 420 (and more in general the rendering unit 430) may perform an auralization (e.g. binauralization), in some examples, but in other examples the auralization (e.g. binauralization) may be performed by an external unit, external to the renderer apparatus 400 or downstream to the rendering unit 430.

The rendered signal 422 may be provided, for example, to loudspeakers and/or headphones 470. The block 470 may be, in addition or alternatively, an auralization device. The sound 472 generated by the loudspeakers and/or headphones 470 may be provided to a human user 449, or another receiving entity. It is here in general assumed that the user 449 is human, but it may be substituted by a living (e.g. animal) being or by a receiving entity (e.g., an automatic system, e.g. a robotic system, e.g. a non-human, or non-human layer).

The contextualization unit 440 (which may be a personalization unit) may receive context-specific data 461, e.g., from the user 449 (or, as will be shown later, from the environment, such as a vehicle). The contextualization unit 440 may provide context-specific rules or parameters 442 and/or 441 to the renderer 420 (or more in general to the rendering unit 430). In particular, it is here shown that context-specific rule and/or parameter 441 may be provided to the core decoder 410. In particular, it is shown that rendering parameters 442 may be provided to the renderer 420 (or more in general to the rendering unit 430). Anyway, the parameters or rules 441 and 442 are here mostly treated unitarily, without too many distinctions. Basically, the distinction between the units 410 and 420 (and the related distinction between the parameters or rules 441 and 442) are here to be understood as merely exemplificative and non-limiting.

The contextualization unit 440 may include an accessibility interface 460. The accessibility interface 460 may provide context-specific data (e.g., in terms of a contextualization profile, or context-specific profile, 462) to a data preprocessor 450.

The data preprocessor 450 may provide the rules and/or parameters 441, 442. The contextualization rules and/or parameters 441, 442 take into account the particular context (e.g., personalization), so as to condition the rendering of the audio scene representation 402, 412, and therefore generate the rendered audio signal 422 by keeping into account the context (e.g., personalization). It may be understood that the rendering is therefore adapted to the contextualization rules and/or parameters 441, 442. It will be shown that there are many possibilities for embodying the contextualization and how to derive the rule(s) and/or parameter(s) 441, 442. It is to be noted that the context-specific rule(s) and/or parameter(s) 441, 442 may be based, for example, on input 461 from the user 449 (or other receiving entity), or for preferences, or for other data (e.g., received from a storage). As can be seen from the input 461 (or more in general context-specific data), the accessibility interface 460 may extract (or more in general derive) context-specific data (e.g., contextualization profile 462), such as personalization data (e.g. personalization profile). In some examples, the contextualization profile 462 is, as such, independent of the particular type of the core decoder 410 and/or the renderer 420 (or more in general the rendering unit 430). It is the data preprocessor 450 which receives the contextualization profile 462 (or, more in general, the context-specific data 462) and reconverts their information into context-specific parameters 441, 442 to the rendering unit 430 (e.g., to the accessibility interface 460).

The renderer apparatus 400 may comprise, or be connected to, a feedback unit 490 (e.g. a unit including at least one of a head tracker, an eye tracker, a positional sensor providing positional information such as gestures, positions, angles, directions, movements, etc.; in some examples the feedback unit 490 may include an accelerometer and/or a gyroscope, but in some examples the feedback unit may include visual sensors, such as an image acquiring sensor, a video acquiring sensor, an audio acquiring sensor, etc.) to provide a feedback information 492 from feedback 491 from the user 449 (or other receiving entity). While in some example the input 461 and the feedback input 491 may be the same (and therefore the line 461 may be substituted by the line 461b), in other examples they may be different and may perform different tasks: the feedback 491 may permit to define the audio signal to be rendered in each time instant, in accordance to the user's feedback (e.g. from head's position, from the distance from virtual objects, the currently displayed viewport, etc.) (or the entity's response to the rendered audio provided thereto), but without changing the personalization data (or more in general context-specific data), which remain the same, and without changing the personalization rule(s) and/or parameter(s) 441, 442 (or context-specific data rule or parameter); while the input (or more in general context-specific data) 461 may be intended as the personalization data (or more in general context-specific data), which change the rendering of the scene. In some examples, the personalization data (or more in general context-specific data) 461 may be acquired during a configuration session, so that a general contextualization profile 462 is derived (e.g. by the contextualization unit, e.g. by the accessibility interface 460), and stored. Therefore, the contextualization profile 462 may be used any time the context is to be present. The contextualization may be a personalization: the input 461 (context-specific data) may be acquired during a configuration session to derive a personalization profile 462, so that, any time the renderer apparatus 400 is used for that particular human user (or another kind of user) 449, the context-specific rule(s) and/or parameter(s) are used which are those specific that are directed to the personalization profile or person-specific profile (or more in general contextualization profile or context-specific profile) 462 (e.g. a specific rule 442 for defining a gain according to the particular positions may be defined based on the profile 462). In contrast, the feedback 491, 492 does not necessarily participate to the definition of any context-specific (e.g. personalization) profile, but simply provides e.g. real-time information on the positions of the user 449, so that the particular rendered audio signal 422, 472 is modulated according to the user's positional feedback 491, 492, e.g. by modulating a specific gain, for example, in accordance to the positional data of the user (but the rule for defining the gain remains unchanged). The user's positional feedback 491, 492 may be understood as being a feedback internal to the scene, while the input 461 (context-specific data) may be understood as modifying the rendering of the audio scene to be represented. In examples, the feedback 491 may be provided as a feedback signal, while the context-specific data 461 may be considered to be a feedforward signal, which is once acquired, and then kept for multiple sessions of the rendering. In examples, the context-specific data 461 may remain unchanged while the feedback signal 491, 492 may be considered to change multiple times (e.g., multiple times per seconds). While FIG. 4b does not show a unit that provides the context-specific data 461, it may be either provided by the same feedback unit 490 or, in other examples, may be provided by a different unit (e.g. operated by a clinician). FIG. 4b shows the arrow 461b indicating that the feedback unit 490 may, optionally, provide the context-specific data 461.

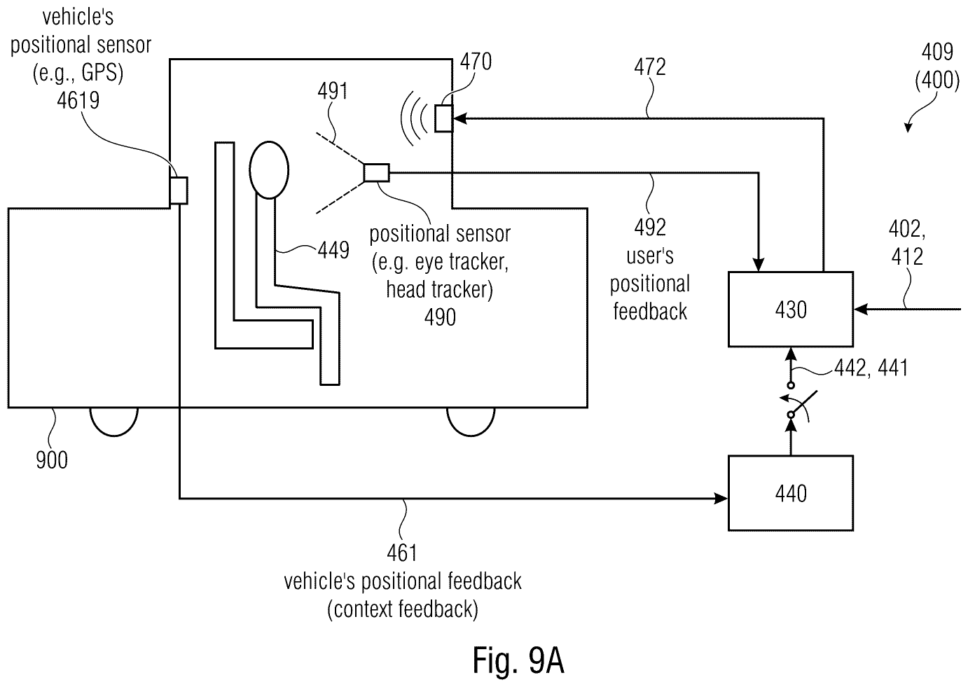

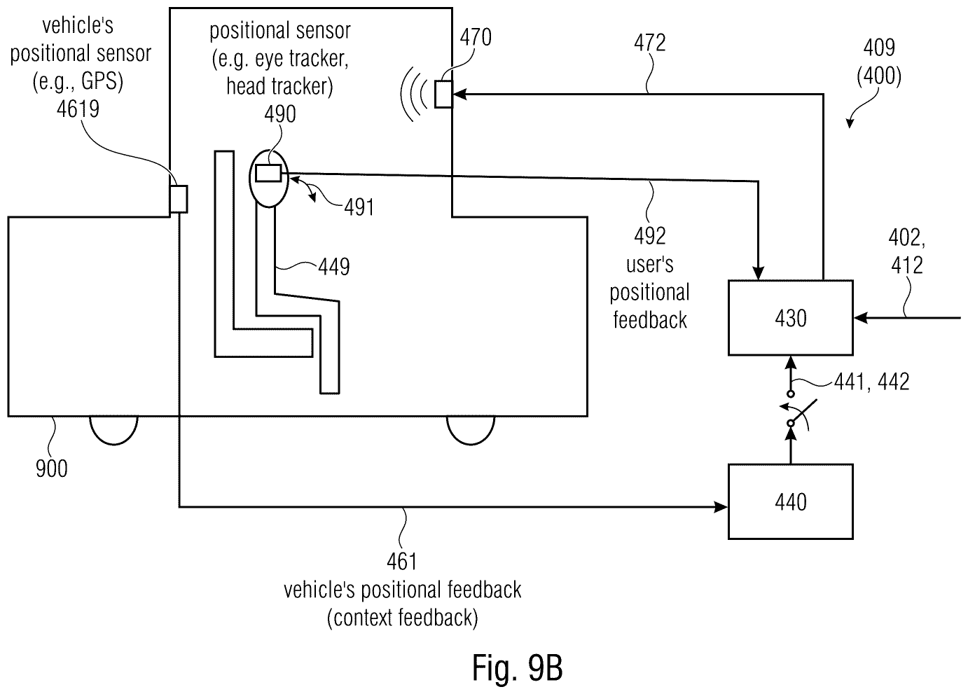

In general terms, both the input 461 (contextualization input or context-specific input, context-specific data) and the feedback 491 may be acquired from at least one sensor including any of a unit including at least one of a head tracker, an eye tracker, a positional sensor providing positional information such as gestures, positions, angles, directions, movements, etc.; in some examples the at least one sensor may include an accelerometer and/or a gyroscope, but in some examples the feedback unit may include visual sensors, such as an image acquiring sensor, a video acquiring sensor, an audio acquiring sensor, etc. The at least one sensor may be, for example, in a immersive device (in which case the at least one sensor may include, for example, at least one gyroscope and/or at least one accelerometer), and/or at least one non-immersive unit (e.g. audio, image and/or video acquiring unit, etc.). It is to be noted that it is not always necessary that the input 491 and the feedback 461 are acquired by the same unit and/or by the same type of sensor: in some examples (e.g. when the input 491 is acquired by a clinician), the input 491 (context-specific data) may be acquired by at least one first sensor, and the feedback 461 may be acquired by a second sensor (which may be the same or a different type of the first sensor). In some cases (e.g. in the case of the vehicle 900 of FIGS. 9a and 9b, see below) the input 491 and the feedback 461 are acquired by units (4619 and 470) which may be different from each other (but in some examples they can be the same unit), but they are acquired simultaneously, while in some other example (e.g. in an example in which a clinician acquires the contextualization input 461), the feedback 461 is acquired (e.g. during an operation session) after the acquisition of the input 491 (which may be acquired in a preceding configuration session).

It is to be noted that the blocks 470 and 490 may be part, for example, of a media content consumption device 475 which may be, for example, applied to a user. The media content consumption device 475 (e.g. immersive device) may be the device for consuming virtual reality content, augmented reality content, and so on. In some cases, the context-specific data 461 may be acquired by the same media content consumption device 475. In alternative, the context-specific data 461 may be acquired by a different device from the media content consumption device 475, and, in some cases, from a device which is different from the renderer apparatus 400. It is to be noted that the media content consumption device 475 is an example, and in some cases the input 461 and/or 491 may be acquired from other, different units (e.g. audio, image and/or video acquiring unit, etc.).

The system 400a for providing the video and audio scene may also include a video renderer 495 which may provide a rendered scene 496 to the user taken from a video bitstream 402a. The video bitstream and the audio bitstream 402 may be obtained from the same source, in some examples. The video renderer 495 may be conditioned by metadata for visualization 482. The metadata for visualization 482 may be received from a point-of-view metadata output unit 480. The point-of-view metadata output unit 480 may be inputted through an input 424 from the contextualization unit 440 (e.g., from the data preprocessor 450). A visualization command may be provided (e.g. by the contextualization unit), for commanding the rendering unit to provide the metadata for visualization 482 to a video consumption device (e.g. the video renderer 495).

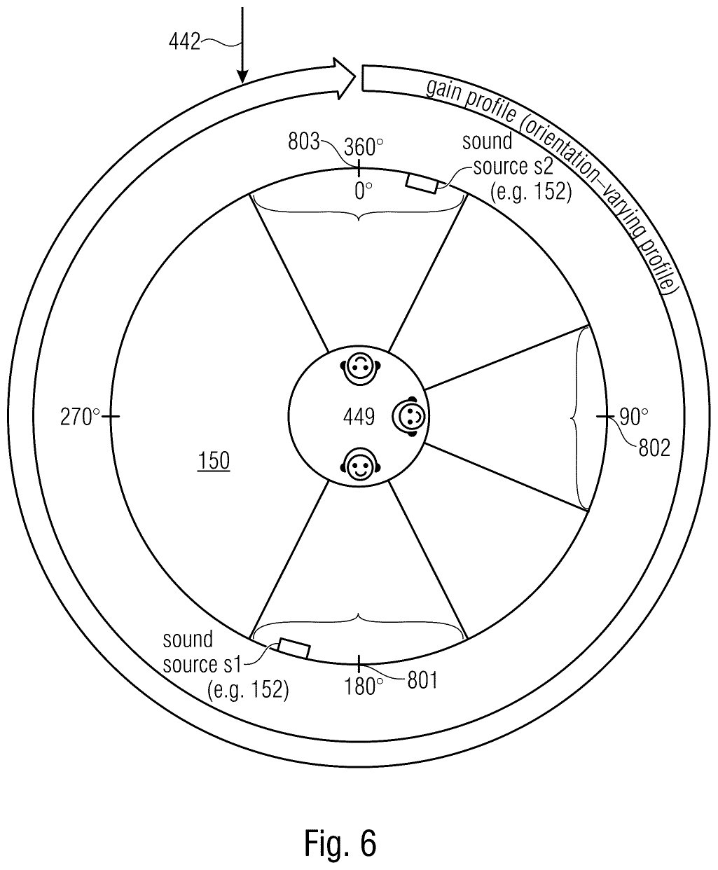

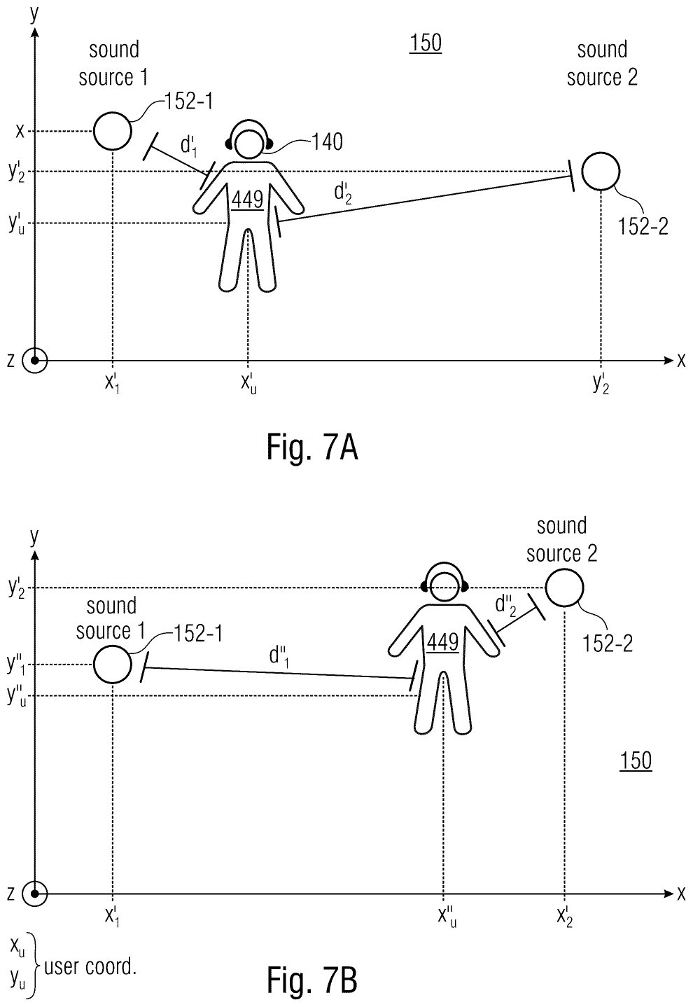

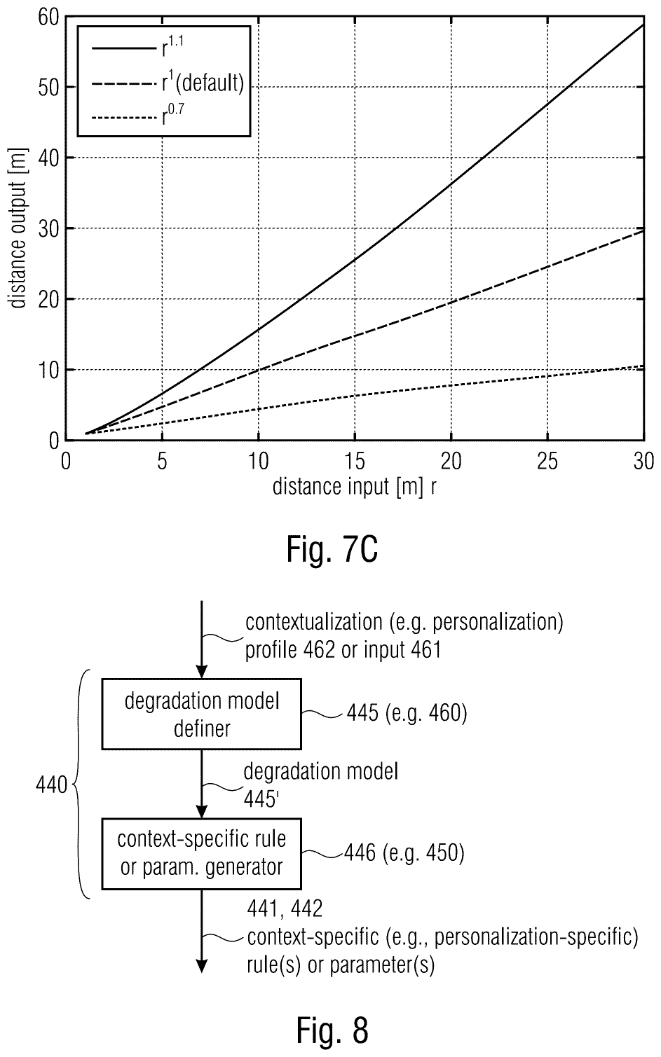

In general terms, it may be understood that the audio signal to be rendered may be rendered according to a particular context-specific (e.g. personalization) rule(s) and/or parameter(s). FIGS. 6, 7a and 7b show examples of context-specific (e.g. personalization) rules or parameters. FIG. 6 shows a user 449 placed (e.g. virtually) in an environment 150 (e.g. a virtual environment). In the environment 150 there are present two objects, e.g. virtual objects (sound source S1, 152 and sound source S2, 152) which are placed at different positions. Each position corresponds, for example, to an orientation of user 449 in the virtual environment 150. 0° corresponds to an orientation 803. 90° corresponds to an orientation 802. 180° corresponds to an orientation 801. Two objects (sound source S1, 152; sound source S2 152) are placed in positions close to the positions 801, 803, respectively. A gain profile varies along the different orientations that the user 449 can take. A gain profile for providing the gain to the rendered audio signal 422 (472) may be conditioned by the context-specific rule(s) and/or parameter(s) 411, 442. For example, according to the gain profile, when the user looks towards the position 803, he/she will experience a higher gain from the sensors S2 and a lower gain from the sounds source S1. On the other side, when the user 449 is directed towards the orientation 801, he/she will experience a higher gain from the sound source S1 and a lower gain from the sound source S2. Apart from this general rule (attenuation law based on orientation), the gain profile may have different attenuation laws, which may be defined by the context specific rule(s) and/or parameter(s) 442. For example, according to the particular personalization (contextualization), the gain profile may be varied based on the particular user 449 (e.g., based on the specific personalization, or contextualization, profile 462). For example, a user 449 with good hearing can have a gain profile which permits to hear differently than a user with 449 impaired hearing. For example, according to some personalization profiles 462, and personalization rules 441, 442 consequent to the personalization profiles, some audio sources may be deactivated. For example, if the sounds source S2 is less relevant than the sounds source S1, then in case of personalization profile 462 indicating that the user 449 has impaired hearing, the less relevant sound source S2 may be deactivated. In some other cases, e.g., in case the personalization profile 462 indicates that the user 449 needs a substitution of some hearing bands, then the gain profile may be modified so as to provide the hearing bands actually properly acquired by the impaired user 449. More in general, however, the gain profile (or more in general the orientation-varying profile) varies according to the particular personalization (or even more in general, according to the particular contextualization) 442.

Another example is provided by FIGS. 7a and 7b, showing a user 449 moving in virtual space 150 from a first position (x′ᵤ, y′ᵤ) (which has a virtual distance d′₁ from the sound source 1, 151-1, and the distance d′₂ from the sound source 2, 152-2). In FIG. 7b, the user has moved from the position (x′ᵤ, y′ᵤ) to the positon (x″ᵤ, y″ᵤ), which now has a distance d″₁ from the sounds source 1, 152-1, and a distance d″₂ from the sound source 2, 152-2. Even in this case, an attenuation law (distance-based attenuation law) may be defined, in particular conditioned by the personalization rule(s) and/or parameter(s) 442 (in turn derived from the personalization profile 442). It will be shown that different rules may be applied, which define the attenuation in function of the distance from the virtual audio source. Even in this case, for example, in case of an impaired user, a particular, personalized rule may be chosen and, for example, some secondary (less relevant) audio sources may be deactivated.

Examples will be provided subsequently which may be based on the examples of FIGS. 6-7b or may be based on different examples.

FIG. 4c shows an example of how the context specific rule(s) and/or parameter(s) 441, 442 may be instantiated by modifying parameters (or more in general metadata) of the (or more in general the audio scene representation 402 or 412 to be rendered). FIG. 4c shows that the audio scene representation 402 or 412 to be rendered may comprise elements (e.g. channels) 402a and/or 412a (which may be part of the bitstream 402 or of the audio elements 412) and metadata 402b and/or 412b. The metadata 402b or 412b may include, for example, parameters used in normal compression operations (e.g., each LPC, linear predictive coding, parameters, whitening parameters, and so on) and/or may include, for example, mixing matrices. The rendering unit 430 (e.g., 410 and or 420) may include a spatial audio processing and synthesis unit 425, which may use modified metadata 402c or 412c, which are modified from the metadata 402b, 412b obtained from the audio scene representation 402, 412. There may be present a metadata modification unit 427 which modifies the metadata 402b or 412b, providing the modified metadata 402c or 412c based on the context-specific rules or parameters 441 or 442 (here indicated with 441b and 442b, respectively). For example, where the metadata 402b, 412b include compression parameters (e.g., LPC parameters, whitening parameters, and so on), then the context specific rule(s) and/or parameter(s) 441b or 442b may modify those parameters (e.g., according to a particular rule and or according to at least one weight, e.g., defined by the contextualization unit 440, e.g., by the data preprocessor 450). Where the metadata 402b, 412b are defined, e.g., in terms of matrixes (e.g. mixing matrixes and/or covariance matrixes and/or correlation matrixes, etc.), then the metadata modification unit 427 may modify the mixing matrices according to the context specific parameter or rule 441b or 442b (for example, some channels may be deactivated, in case of hearing-impaired user 449, or some channels may be attenuated, etc.).

The rendering unit 430 may combine the audio elements 412 based on the metadata (e.g., 412b and/or as included in 412 or as modified) and the context-specific rule or parameter.

In examples, the audio scene representation 402, 412 may include, in metadata, a plurality of metadata sets. The rendering unit 430 may discharge one of the metadata sets based on the at least one context-specific rule or parameter. For example, the rendered audio signal 422 (472) may be conditioned by the remained metadata set.

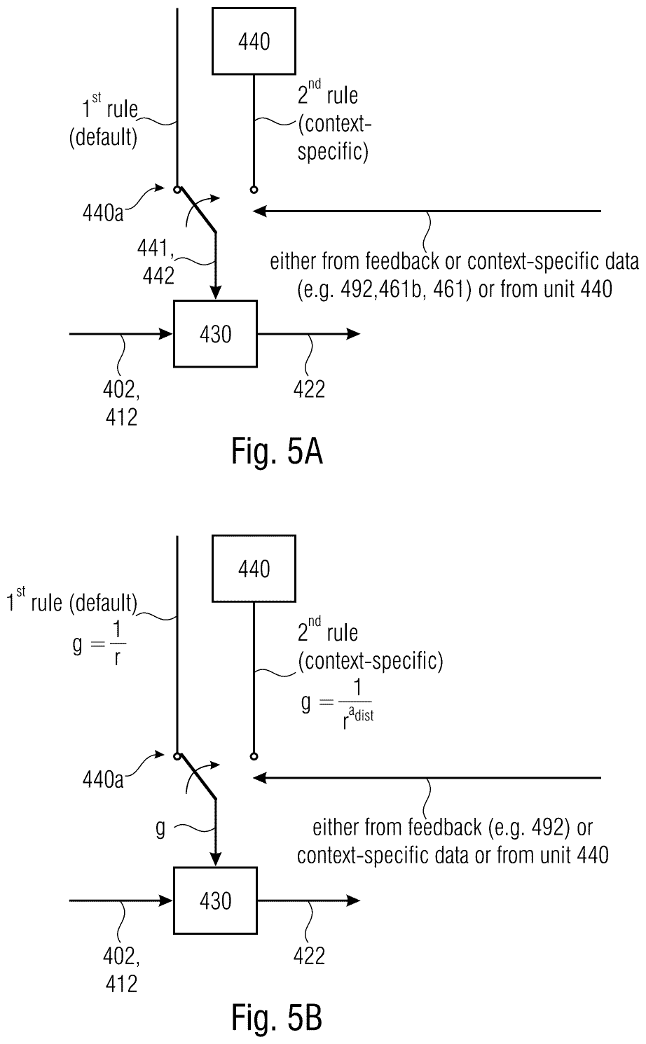

In some cases, there may be a default rule (first rule), which is standard or more in general not conditioned by the context, which is conditioned by the context. An example is provided in FIG. 5a. A switch 440a is shown to switch between the first, default rule, and the second, context-specific rule provided by the contextualization unit 440. Here, the switch 440a may be controlled either by feedback (e.g., 492, such as 461b, or from unit 440), or by another type of input. For this reason, the context-specific rule 441, 442 to be applied to the rendering unit 430 may be applied differently according to the different inputs.

FIG. 8 shows an example which may be used, for example, in clinical applications (e.g., for hearing impaired users). Here, a contextualization profile (e.g., personalization profile) 462 may be provided. The contextualization profile may be provided, for example, by a clinical staff after having evaluated feedback or another input (e.g., 461, 491, 492, 461b) from the user 449. The contextualization profile (e.g., personalization profile) 462 may be independent of the particular renderer apparatus 400. In this case, the contextualization profile 462 may be ingested to the contextualization unit 440 (which may be, for example, a personalization unit), so that the contextualization unit 440 derives context-specific rules or parameters 441, 442 (e.g., personalization specific rules or parameters). For example, a degradation model 445′ may be derived by a degradation model definer 445. The degradation model 445′ may be indicative of the cochlear degradation (or more in general physical and/or cognitive hearing degradation) of the user, or of other degradations. The degradation model 445′ may be provided to a “context-specific rule or parameter generator” 446. The context-specific rule or parameter generator 446 may define the context-specific rules and/or parameters 441, 442 in such a way that the degradation suffered by the user 449 is compensated. For example, if the user 449 suffers of non-properly-hearing from one single ear, the information of the non-properly-hearing ear may be part of the degradation model 445′, so that the context-specific rule and/or parameter generator 446 will change the gain for the loudspeaker to be applied to the particular suffering ear, while the other loudspeaker can have a different gain (e.g., the gain for the suffering ear can be greater than the gain for the normal hearing ear). The same may apply, for example, in case one ear suffers from not recognizing some particular bands, in that case, some bands may be modified in only for one ear, and so on.

The example of FIG. 8 can be substituted, for example, by another technique according to which the contextualization, e.g., personalization) profile 462 also integrates the degradation model 445′, and this is directly provided to the contextualization unit 440, so that the context-specific rule or parameter generator 446 is already ingested with the degradation model. In FIG. 8 it is shown that the degradation model definer 445 corresponds to the accessibility interface 460 and the context-specific rule or parameter generator 446 corresponds to the data preprocessor 450. However, it is not necessary this correspondence holds, and in some examples, blocks 450 and 460 are completely substituted by the blocks 445 and/or 446.

In some examples the contextualization profile 462 may be defined directly by the renderer apparatus 400 itself, e.g. by analyzing a behavioral response of the user 449 (or other kinds of feedback or other input 461, 492, 461b) to some pilot signals 422, 472 provided by the renderer apparatus 400. By analyzing the behavior or the feedback from the user 449, the renderer 400 (and in particular the degradation model definer 445) may generate the degradation model 445′ of its own and/or the context-specific rule or parameter generator 446 may define the context-specific (e.g., personalization specific) rules or parameters 441, 442.

As shown in FIGS. 7a and 7b, the contextualization unit 440 may define the at least one context-specific rule(s) and/or parameter(s) 441, 442 to include at least one context-specific positional rule and/or parameter based on a distance threshold (e.g. between the user 449 and the object 152-1 or 152-2 to be rendered). The rendering unit 430 may be configured to compare a distance (e.g. d′₁ and/or d″₁ and/or d′₂ and/or d″₂) with a distance threshold.

For example, the rule 441, 442 may include refraining from rendering the object in case the distance or position or orientation is over the distance threshold, and render the object in case the distance or position or orientation is below the distance threshold or position threshold or orientation threshold. E.g., in FIG. 7a it could be that the object 152-2 is not rendered because the distance d′₂ is larger than a predetermined distance threshold, while in FIG. 7b it could be that d′₂ is not rendered because the d″₂ is larger than the predetermined distance threshold. This can be defined, for example, by the at least one specific rule and/or parameter 441, 442: for example, for users 449 whose contextualization profile 462 indicates that the haring is impaired, then the at least one rule and/or parameter 441, 442 may provide that at least one object 152-2 to be rendered (e.g. a secondary, less relevant object) is not to be rendered over the predetermined distance threshold. Basically, the relevance of each object may be associated with a priority of the object, and the priority may be compared to a priority threshold in case of the user 449 being hearing impaired, for example (e.g. through the comparison at 440a, see FIG. 5a). Therefore, in case of hearing impaired user 449, the number of objects (e.g. in the audio elements 412) to be rendered is reduced, because the objects with priority (relevance) lower than the priority threshold are excluded from rendering.

As shown in FIG. 6, the contextualization unit 440 may define the at least one context-specific rule and/or parameter 441, 442 to include at least one context-specific positional rule and/or parameter based on a particular orientation (e.g. user's orientation), e.g. by comparing the orientation with an orientation threshold. The rendering unit 430 may be configured to compare an angular position (e.g. 801, 802, 803, etc.) with an angular (orientation) threshold. For example, the rule 441, 442 may include refraining from rendering the object in case the angular position (orientation) is over the predetermined angular (orientation) threshold, and render the object in case the distance or position or orientation is below the predetermined angular (orientation) threshold. E.g., in FIG. 7a it could be that the object s1 is not rendered when the user 449 is directed towards the position 803, and is rendered when the user 449 rotates the head towards the position 801. This may be defined by the at least one rule and/or parameter 441, 442.

More in general, a positional (e.g. gestural) information regarding the user 449 may be taken into account, and one or more positional (e.g. distance and/or angular) measurements may be compared to one or more positional (e.g. distance and/or angular) thresholds, so that a particular object is rendered or not rendered based on the result of the comparison with the one or more positional (e.g. distance and/or angular) thresholds.

Instead of comparing positional measurement(s) (distances, angles, gestural measurements etc.) with threshold(s), it is additionally or in alternative possible that the at least one rule and/or parameter 441, 442 states comparing a gain (e.g. a gain of at least one channel, and/or a gain of at least one object, and/or the gain of at least one ambisonic component) with a gain threshold, so as to refrain from rendering a particular element (e.g. object, channel, or ambisonic element) based on the result of the comparison with the one or more positional (e.g. distance and/or angular) thresholds. This may be based, for example, on the degradation model 445′, so that a hearing-impaired user may have a simplified rendering.

More in general, the relevance of each element 412 (e.g. such as a channel, or ambisonic component, or object) may be associated with a priority (relevance) of the audio element, and the priority may be compared to a priority threshold e.g. in case of the user 449 being hearing impaired, for example (e.g. through the comparison at 440a, see FIG. 5a).

Therefore, e.g. in case of hearing impaired user 449, the number of objects (e.g. in the audio elements 412) to be elements may be reduced, because the audio elements with priority (relevance) lower than the priority threshold are excluded from rendering. This permits a simplified rendering for impaired users. The decision whether to initiate a simplified rendering may be based, for example, on the recognition of the particular user 449, or an a manual selection, or on a pre-selection (e.g. based on pre-setting) e.g. on feedback indicating the physical and/or cognitive hearing degradation of the user 449 (see also below). The priorities (e.g. for each elements, such as object, ambisonic component, and/or channel) may be read, for example, from the bitstream 402 (or more in general in the audio scene representation 402, 412) as metadata, in some examples.

In addition or alternative, the contextualization unit 440 may define the at least one context-specific rule and/or parameter 441, 442 to include at least one positional rule and/or parameter stating a distance-dependent attenuation (like in FIGS. 7a and 7b) or orientation-dependent attenuation (like in FIG. 6) or gesture-dependent attenuation or, more in general, position-dependent attenuation, of the gain (or of another property of the rendered audio signal 422, 472) of an element to be rendered. The at least one positional rule and/or parameter 441, 442 may include a context-specific attenuation parameter to be applied to the context-specific distance-dependent attenuation or position-dependent attenuation or orientation-dependent attenuation. The position-dependent attenuation may be defined as a distance-dependent attenuation inversely proportional to a distance (e.g. d′₁, d″₁, d′₂, d″₂, in FIGS. 7a and 7b) of an object (e.g. source 152-1 or 152-2 in FIGS. 7a and 7b) to be rendered, increased according to the context-specific attenuation parameter. More in particular, the position-dependent attenuation may be defined as a distance-dependent attenuation inversely proportional to the distance of an object to be rendered (e.g. source 152-1 or 152-2 in FIGS. 7a and 7b) elevated by an exponent defined by the context-specific attenuation parameter (here below also indicated as a_{dist}). To allow for faster distance-dependent attenuation, the equation can be augmented to g=1/r^{a}^{_{dist}} (where r may be the distance from the audio source, e.g. one of d′₁, d″₁, d′₂, d″₂, in FIGS. 7a and 7b). With a_{dist}>1, the larger the value a_{dist}, the bigger the gain attenuation for a given distance. With a_{dist}<1, the smaller the value a_{dist}, the less pronounced the gain attenuation for a given distance.

This example is in particular shown in FIG. 5b as an example of FIG. 5a. FIG. 7c shows an example of g=1/r^{a}^{_{dist}}, in which a_{dist}=1.1 or a_{dist}=0.7 or a_{dist}=0.7 or in accordance with the particular context-specific data 461 or 462. Notably, the default value (e.g. for the default rule, e.g. in a first, default mode, see below) may be a_{dist}=1.1.

The at least one rule and/or parameter to provide context-specific information may define at least one channel-specific gain weight, which is to be applied to a corresponding element (e.g. channel, object, ambisonic element), so that the rendering unit 430 applies the channel-specific gain weight to the corresponding element of the rendered audio signal 422.

The channel-specific weight may include a plurality of object-channel-specific gains (e.g. channel-specific gains), each of them being specific to each frequency band, so that the rendering unit 430 applies, according to the context-specific rule and/or parameter, a first channel-specific gain weight to a first frequency band, and a second channel-specific gain weight to a second frequency band. This may follow, for example, the degradation model 445′, so that some frequency bands (which the user 449 hears bad) are attenuated, and the rendering results simplified.

The at least one context-specific rule and/or parameter may include a context-specific reverberation level reducing rule and/or parameter, so that the rendering unit 430 performs a context-specific reduction of the reverberation level based on the at least one context-specific reverberation level reducing rule and/or parameter.

The context-specific rule and/or parameter 441, 442 may be defined to include at least one context-specific early reflection level reducing rule and/or parameter, so that the rendering unit 430 performs a context-specific reduction of the early reflection level based on the at least one context-specific early reflection level reducing rule and/or parameter.

The at least one context-specific rule and/or parameter 441, 442 may include a context-specific dynamic range control rule and/or parameter, so that the rendering unit 430 performs dynamic range control based on the dynamic range control rule or parameter.

The at least one context-specific rule and/or parameter 441, 442 may include a context-specific floor damping parameter to be used by the rendering unit 430 to perform floor damping according to the context-specific floor damping parameter.

The at least one context-specific rule and/or parameter 441, 442 may include a context-specific culling gain parameter to be used by the rendering unit 430 to modify cylinder reflections.

The at least one context-specific rule and/or parameter 441, 442 may include a geometric extent of the acoustic space, so that e.g. a broader acoustic space or a more restricted acoustic space is defined by the at least one context-specific rule and/or parameter 441, 442.

The at least one context-specific rule and/or parameter 441, 442 may associate different potential characteristics of the audio scene representation to different parameters to be applied to the audio scene representation, so as to accordingly render the audio signal 422, 472.

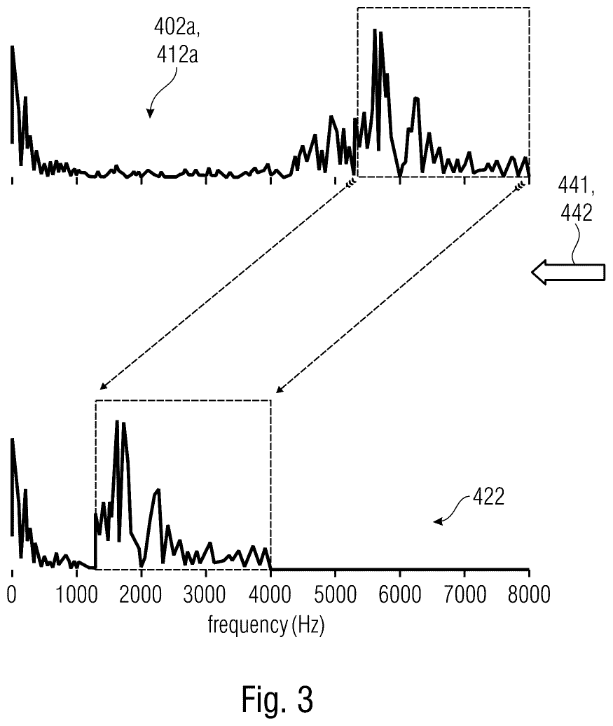

The at least one context-specific rule and/or parameter 441, 442 may include a text-specific rule or parameter for frequency band changing. The at least one context-specific rule and/or parameter for frequency band changing may associate input frequency bands (as in the audio scene representation 402, 412) with output frequency bands (of the rendered signal 422, 472). As shown in FIG. 3, the rendering unit 430 may change at least one frequency band of the audio scene representation 402, 412 onto a different frequency band of the audio elements according to the at least one context-specific rule and/or parameter 441, 442 for frequency band changing. This may be based, for example, on the hearing degradation (e.g. as indicated in the degradation model 445′), so that the frequency bands for which a hearing-impaired user 449 has degraded sensitivity are moved to frequency bands to which the hearing-impaired user 449 has non-degraded (or less degraded) sensitivity. FIG. 3 shows the audio scene representation 402 or 412 (in particular, a channel 402a or 412a of the audio scene representation 402 or 412) in a frequency domain version (e.g. in abscissa being the frequency, in ordinate the value of each bin). Each bin may be moved from a frequency towards a different frequency, in accordance to the rule and/or parameter 441, 442. For example, each moved band may be maintained the same (or at least may be based on the input band). Following common hearing impairments degradations, it may be that the frequency bands are moved from input bands (of representation 402, 412) to output bands (of rendered signal 422, 472) which have lower frequency than the input bands, but this can change according to the particular degradation. It may be, for example, that where the degradation model 445′ indicates that the user's sensitivity is degraded at particular bands, (degraded bands), the contextualization unit 440 defines at least one rule and/or parameter 441, 442 which moves the bands in such a way that the degrades bands are avoided, or that their use is reduced (for example, the degradation model in FIG. 3 may be that the user 449 has a reduced sensitivity between 4000 Hz and 8000 Hz, but an acceptable sensitivity below 4000 Hz, and this is why the bands are moved from between 4000 Hz and 8000 Hz to below 4000 Hz). Therefore, the user's hearing impairment is compensated.

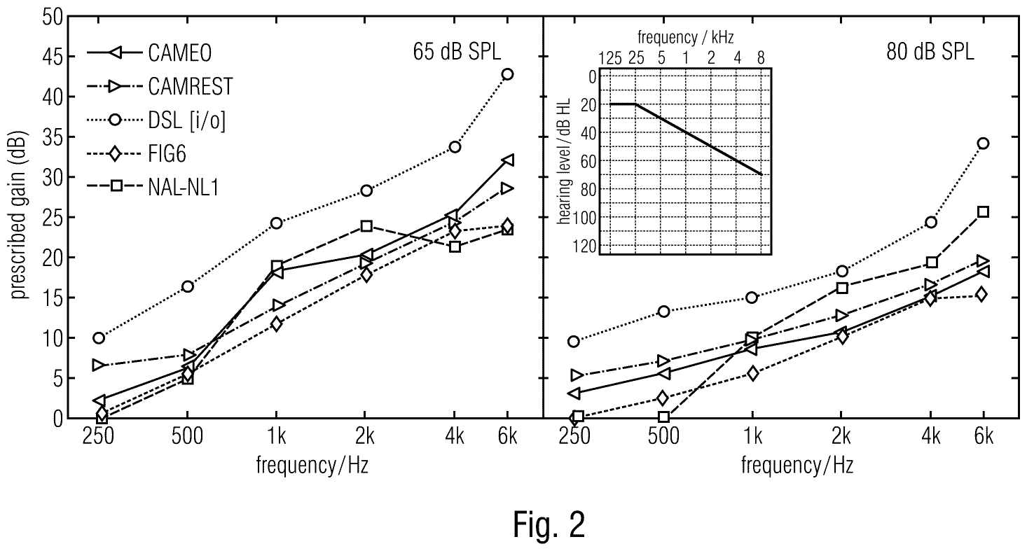

In the example of FIG. 2, the gain (e.g. for each element, such as channel, object, or ambisonic component) changes according to the frequency and the pressure level.

In general terms, in examples the contextualization unit 440 may access to user-specific physical and/or cognitive hearing degradation information (e.g. in the degradation model 445′) providing information on the user-specific physical and/or cognitive hearing degradation. Hence, the contextualization unit 440 may define the at least one context-specific rule and/or parameter as a user-specific rule and/or parameter based on the user-specific physical and/or cognitive hearing degradation information. There may be provided an upload session, to upload user-specific physical and/or cognitive hearing degradation information to derive the user-specific physical and/or cognitive hearing degradation model, and to derive the at least one context-specific rule and/or parameter by applying parameters which compensate the user-specific physical and/or cognitive hearing degradation model.

In examples, the audio scene representation (e.g. the bitstream 402) may include, encoded therein (e.g. in the metadata 402b, 412b), a plurality of contextualization settings. The contextualization settings may be provided to the contextualization unit 440, and the contextualization unit 440 may define a context-specific rule and/or parameter 441, 442 in accordance to the contextualization settings. For example, there may be the indication (e.g. encoded in a particular field of the bitstream 402) of a selection of a pre-stored rule and/or parameter among a plurality of pre-stored rules and/or parameters, and the context-specific rule and/or parameter 441, 442 will be chosen in accordance to the contextualization settings. It may be, however, that a limited plurality of parameters and/or rules are provided in the metadata 402b, 412b, and that the contextualization unit 440 chooses the context-specific parameter and/or rule among the limited plurality on the basis of the context specific data 461.

Now, examples which exemplify FIG. 5a are further developed. The rendering unit 430 may perform (e.g. through the switch 440a) a selection between:
a first, default mode, in which it operates using a first selectable rule and/or parameter 441, 442 (the first selectable rule and/or parameter being either a default rule and/or parameter or a first context-specific rule and/or parameter); and
a second, contextualized mode, in which it operates using at least one second selectable rule and/or parameter instead of the first selectable rule and/or parameter (the second selectable rule and/or parameter being a context-specific rule and/or parameter different from the first selectable rule and/or parameter).

(The example of FIG. 5a is that of the first mode having a default rule independent of the context, but it may be changed into an example having the first mode having a default rule which is also a context-specific rule, while the second rule is a context-specific rule).

The selection (e.g. through the switch 440a) between the first mode and the second mode may be performed manually, or may be performed based on pre-settings.

In alternative (e.g. in which the example of FIG. 5a is also the example of FIG. 8), the selection (e.g. through the switch 440a) between the first (default) mode (having a first rule, either contextualized or independent on the context) and the second (contextualized) mode may be also performed based on the context. For example, feedback (or other input) 461, 461b or 491 (492) may be taken into account.

For example, the selection (e.g. through the switch 440a) may be controlled through measurements (e.g. part of feedback or other input 461, 461b or 491) of biological and/or physiological parameters, so as to select:
the first mode in case the measurements of biological and/or physiological parameters match a predetermined standard model indicative of standard user's physical and/or cognitive hearing, and
the second, contextualized mode in case the measurements of biological and/or physiological parameters do not match the predetermined standard model, thereby indicating degraded user's physical and/or cognitive hearing.

(In the example of FIG. 7c, the first mode may imply the use of g=1/r¹, and the second, contextualized mode may imply the use of g=1/r^{1.1} or g=1/r^{0.7} in accordance with the particular context-specific rule).

The measurements of biological and/or physiological parameters may include measurements pupillometry measures measuring the change of the pupil size. The measurements of biological and/or physiological parameters may include measurements of biological and/or physiological parameters including EEG measurements. The measurements of biological and/or physiological parameters may include measurements of biological and/or physiological parameters including heart rate measurements. The measurements of biological and/or physiological parameters may include measurements of biological and/or physiological parameters including galvanic skin response.

Basically, the measurements of biological and/or physiological parameters may permit to determine the physical state of the user 449, thereby determining whether the user 449 is in a state of physically impaired hearing or attention, and to thereby perform a simplified rendering of the audio signal; otherwise, in case of determination of non-physically impaired hearing or attention, a full rendering (or less simplified rendering) may be performed.

In general terms, the contextualization unit 440 may be inputted with a contextualization input as the context-specific data (461). Further, a user's input (491, 492) may be inputted to the rendering unit (430). The time occurrence of the contextualization input may be lower than the time occurrence of the user's input (491, 492). In general terms, the refresh frequency (e.g. refresh rate) of the context-specific rule may be lower than the input frequency of the user's input (491, 492) (e.g. the refresh period may be longer than the input period). Hence, the context-specific rule has in general a greater inertia than the user's input, and is modified slower.

In general terms, it may be that rendered audio signal (422) is sent to an audio consumption device (475). The renderer apparatus 400 may be configured to be wirelessly connected to the audio consumption device (449). The renderer apparatus may receive a feedback signal (491) from the audio consumption device (475) indicating user's movements or more in general position (e.g., orientation, gesture, etc.), so that the rendering unit (430) provides the rendered audio signal (422) based on the feedback signal (492). The rendered audio signal (422) may be part of an audio scene in a virtual reality or augmented reality environment, the rendered audio signal being defined based on the position and/or orientation of the user. The rendered audio signal (422) may be part of an audio scene in a metaverse environment, the rendered audio signal being defined based on the position and/or orientation of the user in the metaverse. The rendered audio signal (422) may be part of an audio scene in a video game environment, the rendered audio signal being defined based on a position and/or orientation in the video game. The contextualization unit (440) may define and/or change the context-specific data based on a manual input.

In several examples above, at least in the cases directed to cope with hearing-impaired users, rules 141, 142 may be defined to:
1) compensate for the specific hearing impairment and/or
2) simplify the acoustic scene (e.g. less objects, less channels, less ambisonic elements, etc.)

According to another example, the context-specific data 461 may be measurements on background noise. Here, the context-specific rule 441, 442 may be applying a higher gain to the rendered audio signal 422, 472 in the case of higher background noise 461, and a lower gain to the rendered audio signal 422, 472 in case of lower background noise 461. In this case, the background noise 461 may be acquired through the input 461b from a sensor 490 which may e.g. be part of the audio consumption device 475.

It is to be noted that the at least one rule and/or parameter 441, 442 may change according to the particular pressure parameter. For example, the rule 441 may need different parameters (e.g., gains) for different pressure parameters. In the example of FIG. 6 (or respectively in that of FIGS. 7a and 7b), for example, the gain may be changed not only based on the angle (or, respectively, on the distance from the audio source), but also based on the particular pressure parameter, so as to modulate the gain according to the pressure parameter. The at least one rule and/or parameter 441, 442, therefore, may be parametrized on a parameter, such as the pressure level (other parameters may be chosen). The pressure parameter may be, for example, read from the bitstream 402 (or more in general from the audio scene representation 402, 412), e.g. as metadata 402b. More in general, the at least one rule 441, 442 may depend on more than one values (e.g., at least two of pressure, frequency, a positional data such as position, distance, angle, orientation, movement, velocity, acceleration, gesture, etc.).

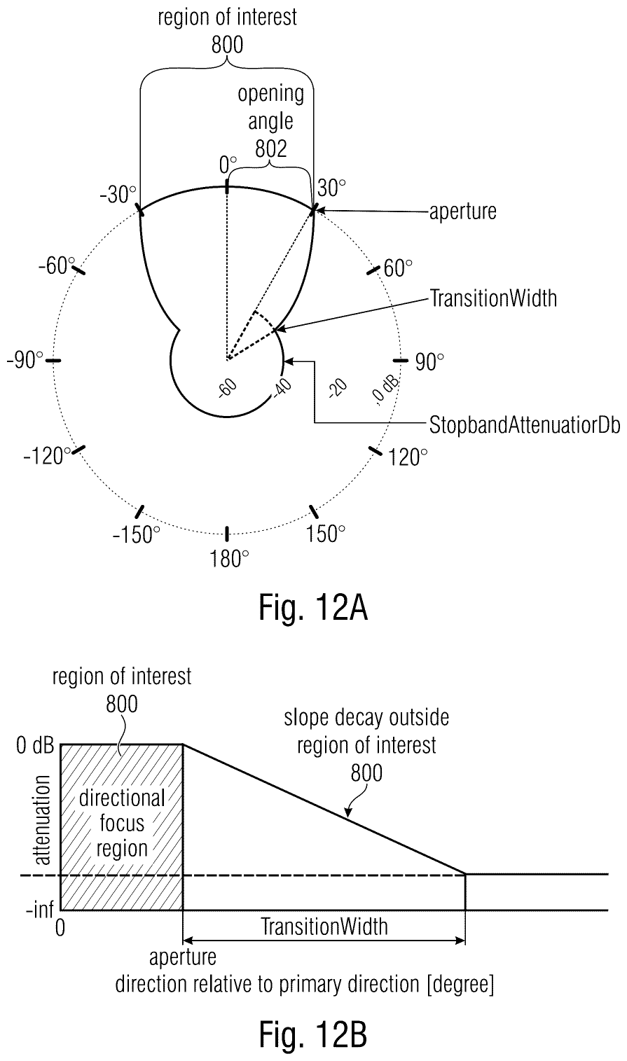

A deeper example of FIG. 6 is shown in FIGS. 11a and 11b (alternative versions thereof being FIGS. 12a and 12b). Here a region of interest 800 is defined (e.g. according to the at least one context-specific rule and/or parameter 441, 442) by an opening angle 802 (e.g. twice the angle). Notably, the region of interest may be defined by the position of the user 449 (e.g. as acquired by a head tracker or eye tracker, which may be the sensor 470 in FIG. 9a, or as acquired by a sensor attached to the user, e.g. like the sensor 470 in FIG. 9b). According to the at least one context-specific rule and/or parameter 441, 442, the region of interest 800 may be so that audio objects of the audio scene representation 402, 412 which are out of the region of interest 800 are either non-rendered or are rendered with lower gain (e.g. attenuated), e.g. according to a slope decay (e.g. so that the angles out of the region of interest 800 but close to the region of interest 800 cause less attenuation than the angles out of the region of interest 800 but more angularly distant from the region of interest 800). The at least one context-specific rule and/or parameter may define the amplitude of the region of interest (e.g. the opening angle 802). The at least one context-specific rule or parameter may define a decay of the gain for the audio objects out of the region of interest to be attenuated according to their particular position. The angles taken into account may be the angle between the user's position and an object to be rendered, for example. (FIGS. 12a and 12b also add a stop band attenuation at a particular decibel value).

Each of FIGS. 9a and 9b shows an example according to which examples above are applied to an environment 900 (e.g. a manned environment), here mostly described as a vehicle 900 (e.g. a manned vehicle, such as a car). The difference of FIGS. 9a and 9b is in that in FIG. 9a the positional sensor 490 is external to the user (e.g. a visual or audio acquisition unit), while in FIG. 9b the positional sensor 490 is joint with the user 449 (e.g. an immersive device) and may be, for example, an accelerometer or a gyroscope. In FIG. 9b the positional sensor 490 is represented as being separated from the loudspeakers 470, but the loudspeakers 470 may be integrated in one single unit (e.g. immersive unit). The system 900 includes a particular example of system 400, also indicated with 409. Here, the rendering unit 430 and the contextualization unit 440 are shown and may be those of FIGS. 4a and/or 4b and, therefore, they may inherit any of those features generally described above and below. A first feedback 492 (corresponding to the feedback 492 of FIG. 4b or other positional or gesture feedback of the user 449 within the vehicle 900) can be a user's positional feedback. Therefore, the element 490 can be a positional sensor (e.g. a sensor which acquires positional measurements, such as measurements of positions and/or orientations and/or gestures, etc. as in particular in FIG. 9a, but also a sensor acquiring accelerations, curves, etc. as in particular in FIG. 9b). The positional sensor 490 may acquire measurements on the positional data from the user 449, e.g. as acquired from acquired images (or other kind of feedback) taken from visual, optical signals 491 as in FIG. 9a, or accelerations as in FIG. 9b. The first feedback 492 as provided from the positional sensor 490 (of FIG. 9a or 9b) toward the rendering unit 430 may therefore permit to condition the rendering the audio scene representation 402 or 412, as described above, by applying contextualization rules and/or parameters 441, 442 which are not defined based on the first feedback 492. Here, the contextualization unit 440 may receive context feedback 461 (context-specific data), which may be different from the first feedback 491, 492. The context feedback 461 may be, for example, vehicle positional feedback, e.g. independent on the positional feedback 461 acquired from the user 449. The vehicle positional feedback 461 may be provided, for example, from a vehicle positional sensor 4619 (e.g., including a global positioning system, GPS), applied to the vehicle 900, and registering the position (e.g. geographic position) of the vehicle 900. The vehicle positional sensor 4619 may therefore provide position information (e.g., position, orientation, and so on) 461 of the vehicle 900.

The vehicle positional feedback 461 may be provided to the contextualization unit 440, e.g., with a reduced time occurrence (reduced refresh rate, or reduced refresh frequency, or reduced refresh period) with respect to the positional feedback 492 of a user 449 (e.g. if the positional feedback 492 is provided n times per second, the vehicle positional feedback 461 is provided m times per second with m<n, e.g. m<<n, e.g. m<n/10). The refresh frequency of the frequency of the at least one context-specific rule and/or parameter (441, 442) may be lower than the input frequency of the user's input (491, 492). Hence, the at least one context-specific rule and/or parameter 441, 442 may change with lower frequency than the user's input. The vehicle context specific rule and/or parameter 441, 442 may therefore condition the rendering of the audio scene representation 402, 412, to be rendered to the user as a rendered audio signal 472 (provided to loudspeakers 470, for example). In examples, it is possible to perform a selection according to which the contextualization unit 440 may be selectively activated vs. deactivated, so that, when deactivated, the rendering of the audio scene representation 402, 412 by the rendering unit 430 results not conditioned by any vehicle positional feedback. This choice may be made, in some examples, manually or by other kinds of selections (e.g., by pre-settings). In the case in which the context specific information 441, 442 is provided to the rendering unit 430, it may be stated that the rendering is conditioned by the context feedback 461 from the vehicle 900 (e.g., from the position and/or orientation of the vehicle), while when the contextualization unit 440 is deactivated, the rendering may follow only (or at least mainly) the user's positional feedback 492. An example may be provided by the case in which the contextualization unit 440 is deactivated, the positions of the virtual audio sources follow the heads movement of the user 449, while when the contextualization unit 440 is activated, the positions of the virtual audio sources may follow the position feedback 461 from the vehicle 900. It is therefore possible to choose between two different operations, in which a particular feedback is predominant (e.g. selectively predominant) over the other (e.g. the predominant may be the unique to be rendered, or the unique to be fully rendered).

In the example of FIG. 9a or 9b, the audio scene representation (e.g. a bitstream 402, e.g. in its version 412) may include a first audio scene representation to be mixed with a second audio scene representation (for example, the first audio scene representation may include sounds relating to an external environment encountered by the vehicle during its movement, and the second audio signal representation may include a music, or another media content, which may be consumed by the user 449). In one example, the first audio signal representation could be to be rendered according to positional data of the vehicle and the second audio signal representation could be to be rendered independently of the positional data of the vehicle. The renderer apparatus 400 (409) may mix (e.g. at the rendering unit 430, e.g. in the renderer 420) the first audio scene representation with the second audio scene representation to obtain the rendered audio signal (422, 472) as a mixed version of the first audio scene representation with the second audio scene representation using mixing weights (e.g. in a spatial synthesis) which are defined (e.g. by the contextualization unit 440), according to the at least one context-specific rule or parameter (441, 442), based on at least the positional data of the vehicle 900. Just to give an example, if a sound is to be rendered which relates to an external position (e.g., a sound that draws the user's attention to the presence of a particular business area, e.g. a rest area or a gas station), the sound to be rendered (encoded in the first audio scene representation) is to be positioned in the direction of the position of the business area, to give the user the impression of the position of the business area. Accordingly, the mixing weights to be used in the mixing are awarded to the loudspeakers which are in the direction of the business area. Hence, the first audio signal representation may be rendered according to positional data (e.g. as acquired as the input 461, context-specific data) according to a relative position of the vehicle and the external position of the business area, in such away that the relative position conditions the mixing weights (e.g. higher gain is awarded to the rendered channels which are associated with the loudspeakers in the direction of the business area. The first audio signal representation may also be rendered according to the relative distance and/or relative orientation of the vehicle from the business area (or more in general the external position). For example, there is increased the mixing weights for the first audio signal representation in case the distance in respect to the second scene representation. Hence, the first audio signal representation may be rendered according to the distance of the vehicle from the external position, so as to increase the mixing weights for the first audio signal representation in respect to the second audio signal representation in case the distance is reduced, and/or to reduce the mixing weights for the first audio signal representation in respect to the second audio signal representation in case the distance is increased. Analogously, in addition or in alternative, the angle between the vehicle 900 and the external position (business area) may be taken into account. The second audio signal representation is to be rendered according to positional data of the user (449), in such a way that the mixing weights follow the user's positional data 491.

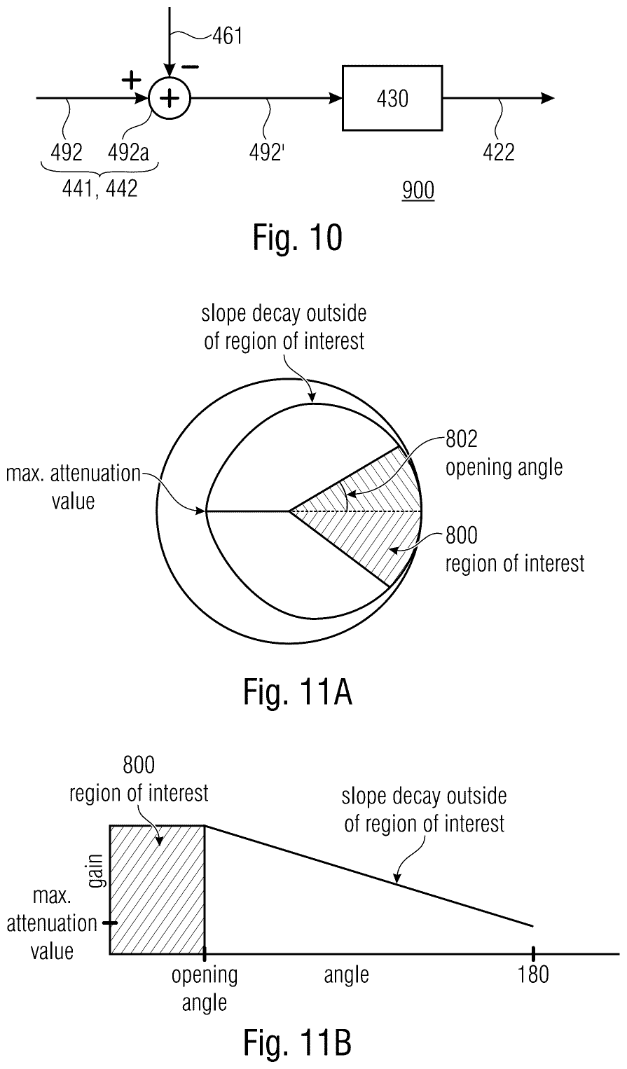

In some examples (in particular in the example of FIG. 9b), it is possible to have an embodiment according to which the user's input 491, 492 is “polished” from the movements due to vehicle's motion (e.g. acceleration), which are acquired as feedback 461 by the vehicle's positional sensor 4619 (this may in particular occur when the positional sensor 490 of FIG. 9b is or includes an accelerometer or a gyroscope). More in particular, the measurement 492 obtained from the feedback 491 may be subtracted of the measurement 461 from the vehicle's positional sensor 4619, thereby having the “polishing” effect. An example is shown in FIG. 10, which shows the feedback 492 to be subtracted of the input (context-specific data) 461 at subtractor 492a, to thereby provide the subtracted feedback 492′ to the renderer unit 430. Then, the subtracted feedback 492′ (“polished” of the accelerations and/or movements of the vehicle 900) may be used for rendering the audio signal 422 by the renderer unit 430. This may be used, in particular, in the cases (like in FIG. 9b) in which both the input (context-specific data) 461 and the feedback 492 are provided, for example by accelerometers and/or gyroscopes: an accelerometer or gyroscope may be used as sensor 4619 to measure the motion of the vehicle 900, and another accelerometer or gyroscope may be used for measuring the positional (e.g. gestural) measurements 492 of the user 449 (this is not properly shown in FIG. 9a, which shows the sensor 470 as an image or sound acquiring sensor; however, since also the positional measurements 491, such as gestures etc. can in principle be impaired by accelerations and movements of the vehicle 900, the inventors have understood that the technique of FIG. 10 may also be applied in the case of FIG. 9b, the sensor 470 being a visual and/or audio sensor, and the feedback 461 includes at least one of user-'s position, angle, orientation, gesture, etc.). It is noted that the at least one context-specific rule or parameter 441, 442 may therefore comprise (or at least define the operation of) the subtractor 492a.

In view of the above, it may be understood that the context-specific rule and/or parameter(s) 441, 442 (whether the context refers to the particular environment or to the particular user 449) permits to increase the degree of personalization (or contextualization) of the audio scene to be rendered, without changing the authoring.

In the examples, the loudspeakers/headphones 470 may be or be part of, for example, an auralization device. The user 449 may be human or non-human, e.g. a digital assistance.

In examples, despite the fact that the outputs (e.g. 470) and/or inputs (e.g. 490) can be physically separated from the renderer apparatus 400 (e.g., the connections 422, 492 and/or 461 may be wireless) then an advantage is achieved in that the rendering (e.g. at renderer unit 430) is performed within the same hardware device (e.g., in the same digital board, or even in the same integrated circuit) of the contextualization (e.g. at the contextualization unit 440), thereby reducing latencies.

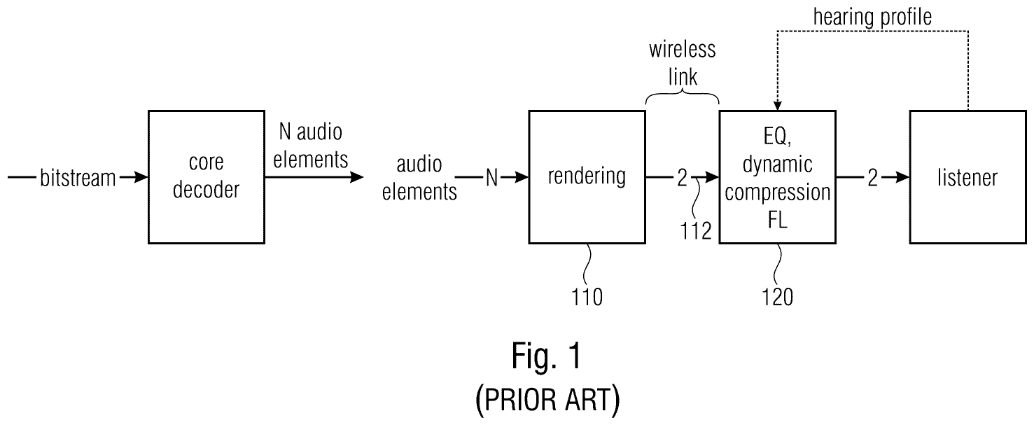

With or without the connections (e.g. 422, 492 and/or 461) being wireless, the rendered audio signal 422 may be, for example, simplified with respect to the audio scene representation 402 and/or 412: hence, unwanted latencies are reduced, because there is processed, according to the at least one rule and/or parameter 441, 442, only the signal which is to be rendered, and nothing more. For example, in the case of the simplification of the audio signal (e.g. in which there is avoided to render the low-priority audio elements in case their priority is below the priority threshold), a transmission of the non-used audio elements is avoided. This contrast with the example of FIG. 1, where the wireless connection between the rendering and the EQ, dynamic compression, FL is impaired by all the rendered signal. Hence, with the present examples there is a reduction of transmission of useless data, in particular in the cases in which there is a wireless transmission of the rendered audio signal 422.

### DISCUSSION

Specific examples are here discussed, e.g. for the rendering apparatus 400 being an accessible immersive device.

In a proposal, the audio renderer 400 may be equipped with an Accessibility Interface 460 that reads, processes and/or generates the user's hearing loss profile and/or other user preferences (e.g., preferences to limit the scene complexity), or another example of input 461. The Data Preprocessor module (unit) 450 then maps the data (hearing loss profile) 462 from the accessibility interface 460 to the internal rendering parameters. These parameters are then parsed to the core decoder 410 and/or the rendering module (renderer) 420 (or more in general by the rendering unit 430), which then renders the audio scene according to the user's needs. In some applications, sensory information 491, such as head pose, pupil size, or eye gazing data, may be provided and be included in creating these rendering instructions.

Some applications may support visualization of the acoustic scene, e.g., to visually highlight the audible objects in the video representation of the VR scenes. That is denoted by the processing box termed PoV (Point of View) description output. For this, the renderer apparatus 400 may provide a Point-of-View Metadata Output Interface 480 that provides metadata 482, such as the location of the currently active sources, or the transmitted text string of a TTS generated voice object. Furthermore, the application could be fed or derive an optimized and/or simpler representation of an audio scene either general or suited to the hearing loss profile that, e.g., focuses on relevant scene element (e.g., speech, sound close to the listener, etc.) and omits distracting ones (background noises, atmospheric sounds, early reflections, reverb, diffuse sound energy etc.).

This example mainly aims to provide personalized usage of 3D and immersive audio renders, such as the MPEG-I renderer, in particular to people (users 449) with hearing impairments. A general idea is to enable rendering instructions, so that the renderer 400 can generate a spatial audio scene 422, 472 in a way that is more enjoyable/intelligible (i.e., accessible) to a specific impaired listener 449.

The following subsection describes some possible processing methods to increase accessibility during rendering:

EQ (equalization)

HRTFs (Head-Related Transfer Functions) that are used for the binauralization can be filtered based on a suggested amplification curve (e.g. as one of the context-specific rule(s) and/or parameter(s) 441, 442) of a hearing profile in an offline process (e.g. from the measurements 461, e.g. further processed with the degradation model 445′ of FIG. 8). This avoids additional latency and runtime complexity. The EQ may need to be processed individually for each ear (e.g. for each channel of the rendered signal 422), to compensate for the different hearing loss of each ear.

### DRC/AGC (Dynamic Range Control/Automatic Gain Control)

Based on the data of the hearing profile (e.g. 441, 442), the dynamic range of the output signal can be modified using DRC functionalities in the renderer pipeline.

### FL (Frequency Lowering)

In the frequency domain of the renderer apparatus 400, one or more mapping rule(s) and/or parameter(s) 441, 442 may determine how the signal energy of frequency bins which are affected by (e.g. severe) hearing impairment is assigned to other frequency bins, where hearing sensitivity remains, so that the spectrum will be compressed (e.g., prior inverse MDCT or MDST).

### Acoustic Scene Simplification

### Limiting the Number of Rendered Sound Elements

### Only Render Important Elements

Example: ISO/IEC 23008-3 MPEG-H Audio. The MPEG-H Decoder (410) may have a decoding parameter dynamic_object_priority which defines the priority of an audio object (e.g. an audio object of the audio elements 412). The audio object (412) may be discarded from rendering and decoding if the priority is lower than a particular threshold (e.g. 7, which may be a priority value assigned to the particular object). If objects (412) are to be discarded (e.g. in consequence of the particular context-specific rule, e.g. based on the selection at 440a in FIG. 5a or 5b), the objects (412) with lowest priority are discarded first according to the rule 441, 442.

Using this functionality, the contextualization unit 440 can signal the renderer unit 430 (e.g. the core decoder 410) to not decode certain audio elements (412, e.g. the objects with lower priority) according to their defined priority.

### Quicker Gain Decay for Distant Sources

Example: The gain attenuation of point sources as a function of its distance is generally computed with g=1/r with r being the distance between source and listener and g being the attenuation gain. (see e.g., ISO/IEC 23090-4:202X MPEG-I part 4 Immersive Audio, WD2, Clause 6.6.12.4—Distance attenuation due to geometrical spreading) To allow for faster distance-dependent attenuation, the equation can be augmented to =1/r^{a}^{_{dist}}.

With a_{dist}>1, the larger the value a_{dist}, the bigger the gain attenuation for a given distance.

With a_{dist}<1, the smaller the value a_{dist}, the less pronounced the gain attenuation for a given distance.

(Notably, this is described by FIG. 5b as a particular case of FIG. 5a)
Limiting the spatial complexity
   Acoustic Flashlight effect: mute all sounds that are outside the current field of view
      Or even make it dynamic based on eye tracking data if supported by HMD
   Reducing contribution from Reverb and Early reflections

Example: In many auditory virtual environments and artificial reverbs, the gain (or the mix) of early reflections and the late reverb to the direct sound can be adjusted. For this specific example see e.g., ISO/IEC 23090-4:202X MPEG-I part 4 Immersive Audio, WD2, Clause 6.6.4.3.7—RI Gain

Here, the following gain parameter are defined that could be modified reduce the contribution of early reflection sound energy:
Tuning Gain g_{tuning}: attenuates the sound level of image sources.
Floor Damping g_{floor}: further reduce the sound level of floor reflections
Culling Gain g_{culling} implements a linear fade-out of image sources which are close to the source distance culling value earlySourceCullingDistanceOrder1 for first-order reflections or earlySourceCullingDistanceOrder2 for second-order reflections
Cylinder Gain g_{cylinder}: a gain value to modify cylinder reflections

### Rendering to Mono

To our knowledge, there is currently no 3D Audio renderer that explicitly features accessibility aspects. The detectability can be achieved via specific user interfaces and the associated signal processing behaviors.

Some discussion is here provided regarding the example of FIGS. 11a and 11b. In order to facilitate the intelligibility and the ability to pay attention in a virtual sound scene, the audio renderer may attenuate (or even mute) sounds that are outside of the visual field (e.g., at the back side of a user), and/or amplify sounds that are in front of the user. A user's movement will of course affect the position and orientation of the user within the scene, thus, this is a dynamic effect as a function of the position input data.

This amplification and attenuation can be achieved by creating a beam function, which can be parameterized from a user interface.

For instance, classic microphone beam pattern can be created, using the equation

$$Γ = {( a + b cos ( δ ) )}^{ω}$$

with δ being the direction of the audio source to be rendered in respect to the particular field direction (e.g. in the example of FIGS. 11a and 11b), and F refers to beamforming weights.

With a and b, ranging between 0 and 1. For instance, the following beam pattern directivity can be realized:
Omnidirectional (i.e., no effect) a=1, b=0, ω=0
Cardioid: a=0.5, b=0.5, ω=0
Hypercardioid: a=0.3, b=0.7, ω=0

The parameter ω>1 sharpens the beam pattern.

An alternative parametrization as here proposed, which is independent from the classic microphone beam pattern could the defined e.g. by specifying the opening angle of the region of interest (i.e. between 0° and 180°) and a parameter that defines the slope of the energy decay outside the region of interest (e.g., −6 dB decay per 10 degree). Maybe an additional parameter defines the desired attenuation of sounds right behind a user (i.e., −16 dB at 180°). Using these parameters, a beam pattern for all directions can be created.

Alternatively, the gaze information provided by an eye tracker (e.g. in FIG. 9a) may be used to estimate the direction a user is looking at, and use this direction as the direction of primary interest (instead of the frontal direction). Then, the beam pattern will be steered to have the main lobe aligning with this direction.

In the example of FIGS. 11a and 11b, the beam pattern (e.g. using the formula Γ=(a+b cos(δ))^{ω} for the beamforming weights or an alternative formula) may be an example of context-specific rule, and may be changed according to the particular context-specific data (e.g. personalization data) 461 (or the input 461b or the feedback 491).

In examples, according to a first context-specific rule (implied by a first context-specific data 461 or the input 461b or the feedback 491) (e.g. in a default mode, e.g. for non-hearing-impaired user), the beam pattern only attenuates the direct sound, but does not attenuate reflections, and in a second context-specific rule (implied by a second context-specific data 461, or the input 461b or the feedback 491) (e.g. in a contextualized mode, e.g. for a hearing-impaired user), the beam pattern not only attenuates the direct sound, but also attenuates early reflections (and/or late reflections).

In alternative (but, in some cases, in the example of FIGS. 11a and 11b or FIG. 6), according to a first context-specific rule (implied by a first context-specific data 461 or the input 461b or the feedback 491) (e.g. in a default mode, e.g. for non-hearing-impaired user), the beam pattern attenuates the direct sound and the early reflections, but does not attenuate late reflections, while in a second context-specific rule (implied by a second context-specific data 461 or the input 461b or the feedback 491) (e.g. in a contextualized mode, e.g. for a hearing-impaired user), the beam pattern not only attenuates the direct sound and the early reflections, but also attenuates the late reflections.

In examples (e.g. in the example of FIGS. 11a and 11b or FIG. 6), according to a first context-specific rule (implied by a first context-specific data 461 or the input 461b or the feedback 491) (e.g. in a default mode, e.g. for non-hearing-impaired user), the beam pattern attenuates the direct sound and the reflection(s) by the same amount in percentage, and in a second context-specific rule (implied by a second context-specific data 461 or the input 461b or the feedback 491) (e.g. in a contextualized mode, e.g. for a hearing-impaired user), the beam pattern attenuates the reflection(s) by a percentage which is greater than the percentage by which the beam pattern attenuates the direct sound.

In examples the context-specific rule can be a composition of rules. For example, the beam pattern (e.g. with the formula Γ=(a+b cos(δ))^{ω}) can be combined with the distance-dependent attenuation (e.g. 1/r^{a}^{_{dist}}). For example, the resulting formula may be attenuation=(a+b cos(δ))^{ω}*1/r^{a}^{_{dist}}). In case of defining multiple rules (e.g. for multiple modes), then it may be possible to change both the rules combined with each other in any of the techniques discussed above and below.

The attenuation due to the beam pattern may affect different components of a sound field differently. For instance:
the beam pattern may only affect the direct sound, but may or may not attenuate early reflections and may or may not attenuate the late reflections (i.e. late reverb)
all early reflections of a specific sound source may be attenuated with the same value the directional sound is attenuated
the attenuation (e.g. a particular first attenuation percentage) of the direct sound component of an audio element due to the beam pattern and the source's direction may be used to attenuate (e.g. by the same first attenuation percentage) all associated early reflections of that audio element in the virtual space
The beam pattern may attenuate sounds differently as a function of their distance to the user.

In some examples, the audio scene representation may include, for at least one element (e.g., at least one object) a metadata indicating that the at least one element (e.g., the at least one object) is not subjected to contextualization (e.g., not personalizable), so that the rendering unit does not perform the contextualization (e.g. personalization) (e.g. the rendering unit may therefore be inhibited from applying the particular contextualization rule (e.g. personalization rule). In other examples, this possibility is not foreseen.

Some discussion regarding FIG. 7c is here provided. For audio objects without an extent, i.e., point source audio objects, the distance attenuation curve produced by the model can be the classical 1/r point source distance attenuation curve, where r represents the distance from source to listener.

For increasing accessibility (e.g. to hearing-impaired users, the tuning parameter α may be introduced for the calculation of the distance-based gain attenuation, changing the distance r to r^{α}. The intended effect is that the depth of the sound scene (comprised of audio objects) can be increased or decreased to the user's needs. For instance, when α>1 the depth of the scene expands and objects that are further away will become less audible and vanish. In opposite, when α<1, the depth of the scene shrinks and objects that are further away will become more audible. A value of α=1 (e.g. default value, e.g. as in the first 7c depicts the effect of the exponent a for the three different values 0.7, 1.0, and 1.1.

The distance exponent a can be provided as part of the context-specific rule.

Some discussion is provided with reference to FIGS. 11a, 11b, 12a, and 12b.

Intended as a functionality for improving accessibility, the directional focus is meant to attenuate distracting sounds from directions outside a spatial region of interest. The focus may be radial symmetric e.g. with one “main lobe” region. Its damping behavior is configurable e.g. with three parameters provided by the contextualization unit 430. The default direction steers towards the frontal viewing direction of the user but can also be re-oriented to other directions, e.g., to enable control through other services or modalities (e.g., eye tracker, handheld controller, etc.).
Audio elements, that are signalled that are associated with the listener may be not processed with a Directional Focus.

### Final Examples

Depending on specific implementation requirements, examples of the present disclosure may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some examples in accordance with the preset disclosure thus comprise a data carrier which comprises electronically readable control signals that are capable of cooperating with a programmable computer system such that any of the methods described herein is performed.

Generally, examples of the present disclosure may be implemented as a computer program product having a program code, the program code being effective to perform any of the methods when the computer program product runs on a computer.

The program code may also be stored on a machine-readable carrier, for example.

Other examples include the computer program for performing any of the methods described herein, said computer program being stored on a machine-readable carrier.

In other words, an example of the inventive method thus is a computer program which has a program code for performing any of the methods described herein, when the computer program runs on a computer.

A further example of the inventive methods thus is a data carrier (or a digital storage medium or a computer-readable medium) on which the computer program for performing any of the methods described herein is recorded.

A further example of the inventive method thus is a data stream or a sequence of signals representing the computer program for performing any of the methods described herein. The data stream or the sequence of signals may be configured, for example, to be transferred via a data communication link, for example via the internet.

A further example includes a processing means, for example a computer or a programmable logic device, configured or adapted to perform any of the methods described herein.

A further example includes a computer on which the computer program for performing any of the methods described herein is installed.

A further example includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some examples, a programmable logic device (for example a field-programmable gate array, an FPGA) may be used for performing some or all of the functionalities of the methods described herein. In some examples, a field-programmable gate array may cooperate with a microprocessor to perform any of the methods described herein. Generally, the methods are performed, in some examples, by any hardware device. Said hardware device may be any universally applicable hardware such as a computer processor (CPU), or may be a hardware specific to the method, such as an ASIC.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

ADDIN ZOTERO_BIBL {“uncited”:[ ],“omitted”:[ ],“custom”:[ ]}CSL_BIBLIOGRAPHY [1] B. C. Moore, “Perceptual consequences of cochlear hearing loss and their implications for the design of hearing aids,” Ear and hearing, vol. 17, no. 2, pp. 133-161, 1996.
[2] I. McClenaghan, L. Pardoe, and L. Ward, “The next generation of audio accessibility,” 2022.
[3] L. A. Ward, “Improving Broadcast Accessibility for Hard of Hearing Individuals: using object-based audio personalisation and narrative importance.,” 2020, doi: 10.13140/RG.2.2.31454.46405.
[4] J. Paulus, M. Torcoli, C. Uhle, J. Herre, S. Disch, and H. Fuchs, “Source Separation for Enabling Dialogue Enhancement in Object-based Broadcast with MPEG-H,” J. Audio Eng. Soc., vol. 67, no. 7/8, pp. 510-521, August 2019, doi: 10.17743/jaes.2019.0032.

1. A renderer apparatus, comprising:
a rendering unit configured to process an audio scene representation to be rendered and to receive at least one context-specific rule or parameter, the rendering unit being configured to generate a rendered audio signal from the audio scene representation conditioned by the at least one context-specific rule or parameter, the context-specific rule or parameter compensating a hearing-impairment; and
a contextualization unit configured to receive and/or derive context-specific data, the contextualization unit being configured to provide the at least one context-specific rule or parameter to the rendering unit based on the context-specific data.

2. The renderer apparatus of claim 1, wherein the rendering unit is configured to process the audio scene representation as comprising audio elements, the rendering unit being configured to generate the rendered audio signal from the audio elements and the at least one context-specific rule or parameter.

3. The renderer apparatus of claim 1, wherein the rendering unit is configured to process the audio scene representation comprising audio elements and metadata, the rendering unit being configured to generate the rendered audio signal from the audio elements, the metadata and the at least one context-specific rule or parameter.

4. The renderer apparatus of claim 3, wherein the metadata comprise positional metadata which provide information on at least one of a position, orientation, directivity, source, and width of at least one object to be rendered, the at least one object to be rendered being part of the audio scene representation, wherein the rendering unit is configured to generate the rendered audio signal from the audio elements, the metadata, and the at least one context-specific rule or parameter.

5. The renderer apparatus of claim 3, wherein the rendering unit is configured to:
modify the metadata based on the at least one context-specific rule or parameter to obtain modified metadata, wherein the rendering unit is configured to apply a spatial audio processing and synthesis to the audio elements based on the modified metadata, or.
apply a spatial audio processing and synthesis to the audio elements based on the metadata and the at least one context-specific rule or parameter.

6. The renderer apparatus of claim 3, wherein the rendering unit is configured to combine the audio elements based on the metadata and the at least one context-specific rule or parameter.

7. The renderer apparatus of claim 1, wherein the contextualization unit is configured to define the at least one context-specific rule or parameter to comprise a context-specific positional rule or parameter which associates context-specific gain weights with distances, positions, gestures and/or orientations, to correspondently apply a context-specific gain weight to an object to be rendered based on the context-specific positional rule or parameter.

8. The renderer apparatus of claim 7, wherein the context-specific positional rule or parameter defines the gain weights to be frequency-dependent, so that the rendering unit applies, according to the positional rule or parameter, a first context-specific gain weight to a first frequency band, and a second context-specific gain weight to a second frequency band.

9. The renderer apparatus of claim 1, wherein the contextualization unit is configured to define the at least one context-specific rule or parameter to comprise a context-specific positional rule or parameter based on a distance threshold or position threshold or orientation threshold, wherein the rendering unit is configured to compare a distance or position or orientation of an object to be rendered with the distance threshold or position threshold or orientation threshold, respectively, so as to refrain from rendering the object in case the distance or position or orientation is over the distance threshold or position threshold or orientation threshold, and render the object in case the distance or position or orientation is below the distance threshold or position threshold or orientation threshold.

10. The renderer apparatus of claim 1, wherein the contextualization unit is configured to define the at least one context-specific rule or parameter to comprise a positional rule or parameter stating a distance-dependent attenuation or position-dependent attenuation or orientation-dependent attenuation, of the gain of an object to be rendered, wherein the positional rule or parameter comprises a context-specific attenuation parameter to be applied to the context-specific distance-dependent attenuation or position-dependent attenuation or orientation-dependent attenuation.

11. The renderer apparatus of claim 1, wherein the contextualization unit is configured to define the at least one context-specific rule or parameter to comprise a context-specific reverberation level reducing rule or parameter, so that the renderer unit performs a context-specific reduction of the reverberation level based on the context-specific reverberation level reducing rule or parameter.

12. The renderer apparatus of claim 1, wherein the contextualization unit is configured to define the at least one context-specific rule or parameter to comprise a context-specific early reflection level reducing rule or parameter, so that the rendering unit performs a context-specific reduction of the early reflection level based on the context-specific early reflection level reducing rule or parameter.

13. The renderer apparatus of claim 1, wherein the contextualization unit is configured to define the at least one context-specific rule or parameter to comprise a dynamic range control rule or parameter, so that the rendering unit performs dynamic range control based on the dynamic range control rule or parameter.

14. The renderer apparatus of claim 1, wherein the contextualization unit is configured to derive the context-specific rule or parameter from background noise, so as to apply a higher gain to the rendered audio signal in the case of higher background noise, and a lower gain to the rendered audio signal in case of lower background noise.

15. The renderer apparatus of claim 1, configured to process the audio scene representation to obtain a version of the audio scene representation comprising audio elements or audio elements and metadata, the renderer apparatus being further configured to generate the rendered audio signal from the audio elements and metadata.

16. The renderer apparatus of claim 15, configured to process the audio scene representation to obtain a version of the audio scene representation comprising audio elements in a core decoder block, and to process the version of the audio scene representation to generate the rendered audio signal from the audio elements in a rendering block.

17. The rendering unit of any claim 1, wherein the contextualization unit is configured to derive a degradation model from the contextualization profile and/or the context-specific data, the degradation model being indicative a specific degradation of the capability of acquiring the rendered audio signal by a specific human user or another audio-receiving entity, wherein the contextualization unit is further configured, based on the degradation model, to define the at least one context-specific rule or parameter to compensate for the specific degradation.

18. The rendering unit of claim 1, configured to perform a simplified rendering in case of determining that the user has an impaired hearing and/or has a reduced cognitive and/or physical sensitivity.

19. The renderer apparatus of claim 1, wherein the contextualization unit is configured to access to user-specific physical and/or cognitive hearing degradation information providing information on a user-specific physical and/or cognitive hearing degradation, and to define the at least one context-specific rule or parameter as a user-specific rule or parameter based on the user-specific physical and/or cognitive hearing degradation information.

20. The renderer apparatus of claim 1, wherein the rendering unit is configured to perform a selection between:
a first, default mode, in which the rendering unit operates using at least one first selectable rule or parameter, wherein the first selectable rule or parameter is either a default rule or parameter or a first context-specific rule or parameter of the at least one context-specific rule or parameter; and
a second, contextualized mode, in which the rendering unit operates using at least one second selectable rule or parameter instead of the first selectable rule or parameter, wherein the second selectable rule or parameter is a context-specific rule or parameter of the at least one context-specific rule or parameter different from the first selectable rule or parameter.

21. The renderer apparatus of claim 1, configured to receive a feedback signal from an audio consumption device indicating user's movements, positions and/or orientations, so that the rendering unit provides the rendered audio signal based on the feedback signal.

22. The renderer apparatus of claim 1, wherein the rendered audio signal is part of an audio scene in a virtual reality or augmented reality environment, the rendered audio signal being defined based on the position and/or orientation of the user.

23. The renderer apparatus of claim 1, wherein the audio elements comprise audio objects.

24. The renderer apparatus of claim 1, wherein the audio elements comprise audio channels.

25. The renderer apparatus of claim 1, wherein the rendering unit is configured to provide the rendered audio signal to an auralization unit.

26. The renderer apparatus of claim 1, configured to receive the audio scene representation in a compressed version, and to perform a first decompressing operation by converting the audio scene representation into a version comprising the audio elements.

27. The renderer apparatus of claim 1, wherein the context-specific data are, or comprise, user-specific personalization data of a particular human user.

28. An audio rendering method, comprising:
processing an audio scene representation generating a rendered audio signal from the audio scene representation conditioned by at least one context-specific rule or parameter, the context-specific rule or parameter compensating a hearing-impairment,
the method comprising generating the at least one context-specific rule or parameter based on the context-specific data.

29. A non-transitory digital storage medium having a computer program stored thereon to perform the audio rendering method, the method comprising
processing an audio scene representation generating a rendered audio signal from the audio scene representation conditioned by at least one context-specific rule or parameter, the context-specific rule or parameter compensating a hearing-impairment,
the method comprising generating the at least one context-specific rule or parameter based on the context-specific data,
when said computer program is run by a computer.
